(19) United States
(12) Patent Application Publication
(10) Pub. No.: US 2026/0233894 A1
(43) Pub. Date: Aug. 13, 2026

(54) REUSABLE MODULAR BOTTLE PLATFORM WITH SINGLE FILL STANDARD, INTERCHANGEABLE DISPENSING HEADS, SHOULDER-SEATED ELASTOMERIC TOPPER WITH SIDEWALL VENTING, AND CLEANABLE SEPARABLE COMPONENTS

(71) Applicant: Pet Parents, LLC, Ankeny, IA (US)

(72) Inventors: Blake Anderssen, Ankeny, IA (US); Mikaela Sperling, Woodward, IA (US); Chuming Zhang, Ankeny, IA (US); Josh King, Ankeny, IA (US)

(21) Appl. No.: 19/535,300

(22) Filed: Feb. 10, 2026

Related U.S. Application Data
(60) Provisional application No. 63/756,436, filed on Feb. 10, 2025.

(51) Int. Cl. B65D 23/00; B05B 11/00; B65D 1/02; B65D 1/40; B65D 75/30

(52) U.S. Cl. CPC B65D 23/006; B05B 11/0037; B65D 1/0246; B65D 1/40; B65D 75/30; B65D 2205/02

(57) ABSTRACT

Various implementations include a reusable bottle platform. The reusable bottle platform includes a bottle defining an interior cavity and having a neck defining a coupling interface configured to receive a dispensing head. The neck defines a channel in fluid communication with the interior volume. The reusable bottle platform includes a fill indicator integrated as a structural feature of an outer surface of the bottle. The fill indicator defines a single predetermined fill volume. The bottle includes at least one aperture extending to the interior cavity. The at least one aperture is positioned at or above a fill elevation corresponding to the fill indicator. The at least one aperture is configured to communicate the interior cavity with an exterior of the bottle such that liquid introduced into the interior cavity above the fill elevation corresponding to the fill indicator is able to flow through the at least one aperture.

### BACKGROUND

Reusable container systems have gained increasing attention as alternatives to single-use packaging, particularly in applications involving liquid products prepared from concentrates. Such systems may employ bottles designed to receive concentrated materials, such as powders, tablets, or liquid concentrates, which are then diluted with water or other liquids to produce ready-to-use solutions. Applications for these systems span household cleaning products, personal care items, pet care formulations, and other consumer goods.

In multi-formula platforms, a single bottle may be intended for use across different product categories or formulations. This reuse introduces engineering considerations that differ from those encountered in single-purpose containers. For example, when a common bottle is used with various concentrates, maintaining consistent dilution ratios across different uses presents challenges. Users may encounter difficulty achieving repeatable fill levels when relying on printed labels or verbal instructions, as such guidance can be subject to interpretation or may become obscured over time.

Dispensing mechanisms for reusable bottles vary in their operational characteristics. Trigger sprayers, pump dispensers, foaming pumps, pour spouts, and other dispensing head types each have different intake requirements and flow behaviors. When a single bottle platform is intended to accommodate multiple dispensing head architectures, coordination between the bottle geometry, fill level, and intake tube positioning becomes a design consideration.

Certain formulations, when mixed with water or other diluents, may generate gas during storage or use. This gas generation can create pressure within a sealed container, potentially leading to bulging, leakage, or difficulty in dispensing. Venting mechanisms have been employed to address internal pressure buildup, though such mechanisms may introduce the risk of liquid escape during handling, tilting, or shaking of the container.

Thorough cleaning of reusable bottles between different formulations presents practical difficulties, particularly when bottles have narrow openings or one-piece constructions that limit access to interior surfaces. Residual material from previous formulations may affect subsequent uses, raising concerns about cross-contamination when switching between product types.

### SUMMARY

Various implementations include a reusable bottle platform. The reusable bottle platform includes a bottle defining an interior cavity and having a neck defining a coupling interface configured to receive a dispensing head. The neck defines a channel in fluid communication with the interior cavity. The reusable bottle platform includes a fill indicator integrated as a structural feature of an outer surface of the bottle. The fill indicator defines a single predetermined fill volume. The reusable bottle platform includes at least one aperture defined by and extending through a wall portion of the bottle that defines the interior cavity. The at least one aperture is positioned at or above a fill elevation corresponding to the fill indicator. The at least one aperture is configured to communicate the interior cavity with an exterior of the bottle such that liquid introduced into the interior cavity above the fill elevation corresponding to the fill indicator is able to flow through the at least one aperture.

In some implementations, the fill indicator includes a molded paw icon formed in an exterior wall of the bottle. In some implementations, the fill indicator is disposed on an upper sidewall region of the bottle relative to the gravitational axis.

In some implementations, the bottle includes a longitudinal axis, and the fill indicator is disposed between 0.2 cm and 12 cm below a neck datum measured along an exterior surface of the bottle. In some implementations, the neck datum is defined as a reference plane perpendicular to the longitudinal axis of the bottle as measured from a lower boundary of the coupling interface.

In some implementations, the at least one aperture is defined by a sidewall region of the wall portion of the bottle.

In some implementations, the reusable bottle platform further includes a removable elastomeric topper configured to seat on an exterior surface of the bottle. In some implementations, the bottle includes a continuous circumferential shoulder groove formed around the exterior of the bottle at a shoulder region located below the neck, and the topper is configured to seat within the continuous circumferential shoulder groove. In some implementations, the topper is configured to be retained on the bottle by elastic interference between the topper and the shoulder groove. In some implementations, the topper includes a plug portion configured to seal the at least one aperture.

In some implementations, the at least one aperture includes a first aperture and a second aperture. In some implementations, the topper includes a plug portion configured to seal the first aperture and a vent channel extending from an inlet region aligned with the second aperture to an outlet region open to the exterior of the bottle. In some implementations, the vent channel is a molded recessed groove formed in the topper. In some implementations, the first aperture has a first cross-sectional dimension and the second aperture has a second cross-sectional dimension. In some implementations, the first cross-sectional dimension is larger than the second cross-sectional dimension.

In some implementations, the reusable bottle platform further includes an internal shield rib disposed on an interior surface of the bottle adjacent the second aperture. In some implementations, the internal shield rib projects inward from the wall portion and downward relative to a gravitational axis. In some implementations, the internal shield rib extends across 7 percent to 95 percent of a horizontal span of the second aperture. In some implementations, the internal shield rib is spaced from the second aperture by a distance between 0.2 mm and 20 mm.

In some implementations, the topper includes a tongue portion extending axially from the topper. In some implementations, the tongue portion includes the fill indicator.

In some implementations, the bottle includes a top bottle portion, a bottom bottle portion, and a coupling. In some implementations, the top bottle portion is separably couplable to the bottom bottle portion by the coupling. In some implementations, the top bottle portion and the bottom bottle portion together define the interior cavity when assembled. In some implementations, the reusable bottle platform further includes a gasket disposed at the coupling between the top bottle portion and the bottom bottle portion. In some implementations, the coupling includes a threaded coupling. In some implementations, the threaded coupling and the gasket are cooperatively configured such that sealing engagement between the top bottle portion and the bottom bottle portion occurs when the bottom bottle portion has a mating thread profile and gasket-engagement geometry corresponding to the top bottle portion. In some implementations, the fill indicator is disposed on the top bottle portion such that the fill indicator remains fixed and visible from the exterior of the bottle regardless of which bottom bottle portion is attached.

In some implementations, the reusable bottle platform further includes a dispensing head removably couplable to the coupling interface. In some implementations, the dispensing head includes an intake tube extending into the interior cavity.

In some implementations, the dispensing head includes a keyed engagement feature configured to correspond to a specific feature of the removable elastomeric topper such that the dispensing head is installable on the coupling interface when the removable elastomeric topper having the corresponding specific feature is seated on the bottle. In some implementations, the keyed engagement feature is configured to align the vent channel of the removable elastomeric topper with the second aperture when the dispensing head is assembled on the coupling interface.

In some implementations, the topper is configurable between a first configuration in which the first aperture is sealed while the vent channel communicates the second aperture with the exterior of the bottle, and a second configuration in which the topper seals both the first aperture and the second aperture.

Various other implementations include a unit-dose concentrate article. The unit-dose concentrate article includes an enclosure enclosing a quantity of a material. The enclosure is defined by structural and packaging characteristics independent of chemical composition. The unit-dose concentrate article includes printed instructions provided on the enclosure. The printed instructions are configured to instruct a user to add the quantity of the concentrated material to an interior cavity defined by a bottle of a reusable bottle platform. The bottle includes a fill indicator integrated with an outer surface of the bottle. The printed instructions are configured to instruct a user to fill the interior cavity of the bottle of the reusable bottle platform with a liquid to a position corresponding to the fill indicator integrated as a molded structural feature of an outer surface of the bottle, without reference to a specific volume. The printed instructions further include a dispensing head selection mapping identifying a dispensing head type compatible with the quantity of the material when mixed to the fill indicator.

In some implementations, the dispensing head selection mapping identifies at least one head type selected from a spray head, a foaming head, or a pump head. In some implementations, the enclosure includes a visual identifier configured to correspond to a color-coded topper associated with the dispensing head type identified by the dispensing head selection mapping. In some implementations, the printed instructions are configured to instruct use of a topper corresponding to the dispensing head type identified by the dispensing head selection mapping.

In some implementations, the printed instructions are configured to instruct filling the interior cavity of the bottle of the reusable bottle platform to an edge of a visual fill indicator formed on the outer surface of the bottle of the reusable bottle platform.

In some implementations, the enclosure includes one or more tactile features configured to correspond to tactile features of a topper or dispensing head identified by the dispensing head selection mapping.

In some implementations, the enclosure includes a water-soluble or water-dispersible material configured to dissolve or disintegrate upon contact with the liquid.

Various implementations include a reusable bottle platform. The reusable bottle platform includes a bottle defining an interior volume and having a neck defining a coupling interface, an integrated fill indicator formed as a molded structural feature on the bottle, and a plurality of dispensing heads of different dispensing architectures removably couplable to the coupling interface. The integrated fill indicator defines a single predetermined fill volume that defines a dilution volume for preparing a solution within the bottle. Each dispensing head includes an intake tube extending into the interior volume. The bottle is configured such that, for each dispensing head of the plurality of dispensing heads, when the bottle is in an upright orientation defined by gravity and filled to a fill condition in which a liquid surface is coincident with the integrated fill indicator and no liquid volume is present above the integrated fill indicator, a distal end of the intake tube is positioned below the liquid surface corresponding to the integrated fill indicator. The single predetermined fill volume is invariant across the plurality of dispensing heads. The integrated fill indicator defines a fill elevation that is at or below at least one aperture formed through a wall portion of the bottle that bounds the interior volume. The at least one aperture is configured to communicate the interior volume with atmosphere such that liquid introduced above the fill elevation is discharged or cannot be stably retained within the bottle, thereby mechanically inhibiting retention of liquid above the single predetermined fill volume.

In some implementations, the bottle includes a separable top bottle portion including the neck and the integrated fill indicator, a separable bottom bottle portion, a user-separable coupling joining the separable top bottle portion to the separable bottom bottle portion, and a gasket disposed at the user-separable coupling. In some implementations, the separable top bottle portion and the separable bottom bottle portion define the interior volume configured to retain the solution when assembled. In some implementations, the integrated fill indicator includes a molded paw icon. In some implementations, the upright orientation is defined by gravity such that the liquid surface is level due to gravity. In some implementations, the integrated fill indicator is disposed on an upper sidewall region of the bottle. In some implementations, the integrated fill indicator is disposed between 0.2 cm and 12 cm below a neck datum measured along an exterior surface of the bottle. In some implementations, the plurality of dispensing heads includes at least two dispensing heads selected from the group consisting of a trigger sprayer, a pump dispenser, a mist sprayer, a foaming pump, a pour spout, a brush-and-dispense head, and a squeeze valve. In some implementations, the bottle includes a separable top bottle portion and a separable bottom bottle portion coupled by a user-separable coupling and a gasket. In some implementations, the integrated fill indicator is disposed on the separable top bottle portion. In some implementations, the reusable bottle platform is configured for mixing a concentrate including a powder, a tablet, or a liquid concentrate with water filled to the integrated fill indicator under the fill condition to produce a solution having a flow characteristic within a flow-operable range for a dispensing head of the plurality of dispensing heads. In some implementations, when the solution is prepared by filling the bottle to the integrated fill indicator and a dispensing head of the plurality of dispensing heads installed on the bottle, the system produces a dispense output selected from a foam output, a spray output, a mist output, or a pour output. In some implementations, a refill used to prepare the solution is associated with a vent-enabled mode or a sealed mode, and the system is configured for use with a corresponding topper configuration. In some implementations, different dispensing heads of the plurality of dispensing heads produce different dispense outputs when used with the same single predetermined fill volume. In some implementations, use of different dispensing heads with the same single predetermined fill volume produces different numbers of discrete dispensing actions per filled bottle. In some implementations, a pump-type dispensing head produces a first number of pump actuations per filled bottle and a spray-type dispensing head produces a second number of spray actuations per filled bottle. In some implementations, each dispensing head is configured to receive an intake tube having a universal intake tube architecture compatible with a plurality of dispensing head types. In some implementations, a length of the intake tube is selected based on a total internal depth of the bottle defined by a selected bottom bottle portion. In some implementations, different bottom bottle portions defining different total internal capacities are paired with intake tubes of different lengths while maintaining a common intake tube interface with the dispensing head. In some implementations, the universal intake tube architecture permits a single dispensing head type to be used interchangeably with multiple bottle configurations by selection of an intake tube length corresponding to the selected bottom bottle portion. In some implementations, different dispensing heads of the plurality of dispensing heads include intake tubes having different intake tube architectures corresponding to the respective dispensing head architectures. In some implementations, the intake tube architecture of each dispensing head is selected based on at least one of internal flow paths, actuation mechanisms, or flow requirements of the dispensing head. In some implementations, the intake tube architecture and a length of the intake tube are coordinated with both the dispensing head type and a selected bottom bottle portion. In some implementations, a first dispensing head includes a first intake tube architecture having a first length corresponding to a first bottle configuration, and a second dispensing head includes a second intake tube architecture having a different length corresponding to the same or a different bottle configuration. In some implementations, the intake tube is selected from stepped intake tubes, tapered intake tubes, rigid intake tubes, semi-rigid intake tubes, flexible intake tubes, or combinations thereof. In some implementations, the intake tube is formed integrally with the dispensing head or is removably attachable to the dispensing head. In some implementations, the at least one aperture is formed through a sidewall region, a shoulder region, or a top wall region of the bottle.

Various other implementations include a unit-dose concentrate article. The unit-dose concentrate article includes an enclosure defining a single-use package and enclosing a quantity of a concentrated material, and printed instructions provided on the enclosure. The enclosure is defined by structural and packaging characteristics independent of chemical composition. The printed instructions instruct a user to add the quantity of the concentrated material to a reusable bottle platform having an integrated fill indicator and to fill the reusable bottle platform with liquid to a position corresponding to the integrated fill indicator, without reference to a numeric volume. The printed instructions further include a dispensing head selection mapping identifying a dispensing head type compatible with the quantity of the concentrated material when mixed to the integrated fill indicator.

In some implementations, the dispensing head selection mapping identifies at least one head type selected from a spray head, a foaming head, or a pump head. In some implementations, the enclosure includes a visual identifier configured to correspond to a color-coded topper associated with the identified dispensing head type. In some implementations, the printed instructions instruct use of a topper corresponding to the identified dispensing head type. In some implementations, the printed instructions instruct filling the reusable bottle platform to a bottom edge of a visual fill indicator formed on the reusable bottle platform. In some implementations, the enclosure includes one or more tactile features configured to correspond to tactile features of a topper or dispensing head identified by the dispensing head selection mapping. In some implementations, the quantity of the concentrated material has a mass between approximately 0.2 grams and 453 grams. In some implementations, the enclosure includes a water-soluble or water-dispersible material configured to dissolve or disintegrate upon contact with liquid.

Various other implementations include a reusable bottle platform. The reusable bottle platform includes a bottle defining an interior volume and having an exterior sidewall and a neck defining a coupling interface, a first aperture and a second aperture formed through a wall portion of the bottle that bounds the interior volume, a continuous circumferential shoulder groove formed around the exterior of the bottle below the neck, and a removable elastomeric topper seated in the shoulder groove. The first aperture and the second aperture are disposed in an upper region of the bottle. The topper includes a plug portion configured to seal the first aperture and a formed vent channel molded into the topper and extending from an inlet region aligned with the second aperture to an outlet region open to atmosphere. The topper is retained on the bottle by elastic interference with the shoulder groove and is axially secured by a dispensing head coupled to the coupling interface. Gas generated within the interior volume is routed from the second aperture through the vent channel to atmosphere while liquid escape through the second aperture is inhibited during upright storage and ordinary handling.

In some implementations, the first aperture has a larger cross-sectional dimension than the second aperture. In some implementations, the topper includes a downwardly extending tongue portion aligned with the second aperture. In some implementations, the tongue portion includes an integrated fill indicator formed as a molded paw icon. In some implementations, the second aperture is disposed between 0.2 cm and 12 cm below a neck datum. In some implementations, the vent channel is a molded recessed groove formed in the topper body. In some implementations, the reusable bottle platform further includes an internal shield rib formed on an interior surface of the bottle adjacent the second aperture. In some implementations, the internal shield rib projects upward relative to the second aperture. In some implementations, the internal shield rib extends across 7 percent to 95 percent of a horizontal span of the second aperture. In some implementations, the internal shield rib is spaced from the second aperture by a distance between 0.1 mm and 25 mm. In some implementations, the dispensing head compresses the topper against an annular seating surface of the bottle. In some implementations, the dispensing head includes at least one keyed engagement feature configured to mechanically engage a corresponding keyed feature of the topper to define a predetermined seating orientation between the dispensing head and the topper. In some implementations, the keyed engagement feature of the dispensing head differs in at least one of geometry, number, spacing, orientation, or profile between dispensing head configurations. In some implementations, the topper includes a corresponding keyed feature configured to receive a dispensing head having a matching keyed engagement geometry, such that a dispensing head having a non-matching keyed engagement geometry is prevented from fully seating or sealing the topper. In some implementations, the dispensing head includes a lower sealing surface configured to seat within a recess formed in the topper when the keyed engagement geometry matches, thereby forming an additional sealing interface between the dispensing head and the topper. In some implementations, the keyed engagement feature maintains alignment of the vent channel with the second aperture during installation and use. In some implementations, the keyed engagement geometry of the dispensing head corresponds to a topper having a venting configuration corresponding to a formulation class. In some implementations, the topper includes a first configuration sealing the first aperture and a second configuration sealing both the first aperture and the second aperture. In some implementations, the dispensing head is selected from a trigger sprayer, a pump dispenser, a mist sprayer, or a foaming pump.

Various other implementations include a kit. The kit includes a reusable bottle platform, at least one topper configured to seat on the bottle, and at least one unit-dose concentrate article including an enclosure enclosing a quantity of a concentrated material. The reusable bottle platform includes a bottle having an interior volume and an integrated fill indicator defining a single predetermined fill volume, and a plurality of dispensing heads of different dispensing architectures selectively couplable to the bottle. The unit-dose concentrate article includes instructions directing a user to add the quantity of the concentrated material to the bottle and to fill the bottle with liquid to the integrated fill indicator. The instructions further include a dispensing head selection mapping identifying a dispensing head of the plurality of dispensing heads for use with the unit-dose concentrate article when mixed to the single predetermined fill volume.

In some implementations, the at least one topper is associated with the dispensing head identified by the dispensing head selection mapping. In some implementations, the unit-dose concentrate article includes a visual identifier corresponding to a visual identifier of the topper associated with the identified dispensing head. In some implementations, the unit-dose concentrate article includes a tactile feature corresponding to a tactile feature of at least one of the topper or the identified dispensing head. In some implementations, the instructions direct filling the bottle to a bottom edge of a visual fill indicator formed on the bottle. In some implementations, the dispensing head selection mapping identifies a head type selected from a spray head, a foaming head, or a pump head. In some implementations, the enclosure of the unit-dose concentrate article includes a water-soluble or water-dispersible material. In some implementations, the kit includes a plurality of unit-dose concentrate articles, each configured for use with the same integrated fill indicator and different dispensing heads of the plurality of dispensing heads.

Various other implementations include a reusable bottle. The reusable bottle includes a separable top bottle portion including a neck defining a coupling interface and a mouth, a separable bottom bottle portion, a direct, user-separable threaded coupling joining the separable top bottle portion to the separable bottom bottle portion, and a gasket disposed at the threaded coupling. The threaded coupling and the gasket are cooperatively configured such that sealing engagement between the top bottle portion and the bottom bottle portion occurs when the separable bottom bottle portion has a mating thread profile and gasket-engagement geometry corresponding to the separable top bottle portion. A bottom bottle portion lacking the mating thread profile and gasket-engagement geometry is mechanically prevented from achieving a sealed assembled condition with the separable top bottle portion.

In some implementations, the gasket is positioned and dimensioned to achieve sealing upon a predetermined axial compression defined by the mating thread profile, such that a separable bottom bottle portion having a non-matching thread profile is unable to compress the gasket to form a liquid-retaining seal. In some implementations, a non-matching bottom bottle portion is prevented from fully seating due to axial interference between thread profiles. In some implementations, the gasket is seated in a circumferential groove positioned relative to a termination of the thread profile. In some implementations, the threaded coupling has a diameter between 15 mm and 150 mm and a thread height between 2 mm and 30 mm. In some implementations, the user-separable coupling includes a threaded coupling. In some implementations, the gasket is seated in a circumferential groove. In some implementations, the separable top bottle portion includes an integrated fill indicator defining a single predetermined fill volume. In some implementations, the user-separable coupling is disposed below a thread region of the coupling interface.

Various other implementations include a modular bottle kit. The modular bottle kit includes a common top bottle portion including a neck defining a coupling interface and an integrated fill indicator defining a single predetermined fill volume, and a first bottom bottle portion and a second bottom bottle portion each configured to couple to the common top bottle portion via a user-separable coupling and a gasket. The common top bottle portion coupled to the first bottom bottle portion defines a first total capacity. The common top bottle portion coupled to the second bottom bottle portion defines a second total capacity different from the first total capacity.

In some implementations, interchange of the modular bottom bottle portions varies the internal liquid volume below the fixed fill elevation while the fill elevation remains invariant on the top bottle portion. In some implementations, the integrated fill indicator is disposed on the common top bottle portion such that the integrated fill indicator remains visible when either the first bottom bottle portion or the second bottom bottle portion is coupled. In some implementations, the plurality of dispensing heads includes dispensing heads having intake tubes of different lengths selected based on the bottom bottle portion coupled to the common top bottle portion. In some implementations, at least one dispensing head is configured to receive intake tubes of different lengths corresponding to different bottom bottle portions while maintaining a common intake tube interface. In some implementations, different dispensing heads include intake tubes having different intake tube architectures corresponding to the dispensing head type and the selected bottom bottle portion. In some implementations, the modular bottle kit further includes at least one concentrate configured to be diluted with water filled to the integrated fill indicator when the concentrate is used with one of the first bottom bottle portion or the second bottom bottle portion. In some implementations, using the concentrate with a bottom bottle portion defining a different dilution volume produces a dilution outside a flow-operable range for a dispensing head. In some implementations, the common top bottle portion is configured to receive a plurality of dispensing heads via the coupling interface. In some implementations, the user-separable coupling includes a threaded coupling. In some implementations, the gasket is seated in a circumferential groove.

### BRIEF DESCRIPTION OF DRAWINGS

Example features and implementations of the present disclosure are disclosed in the accompanying drawings. However, the present disclosure is not limited to the precise arrangements and instrumentalities shown. Similar elements in different implementations are designated using the same reference numerals.

FIG. 1 is an isometric view of a reusable modular bottle platform with a trigger sprayer dispensing head, according to one implementation.

FIG. 2 is an exploded isometric view of the reusable modular bottle platform shown in FIG. 1.

FIG. 3 is a rear orthogonal view of the reusable modular bottle platform shown in FIG. 1.

FIG. 4 is a front orthogonal view of the reusable modular bottle platform shown in FIG. 1.

FIG. 5 is a side orthogonal view of the reusable modular bottle platform shown in FIG. 1.

FIG. 6 is a cross-sectional view of the reusable modular bottle platform shown in FIG. 1.

FIG. 7 is a rear orthogonal view of a bottle of the reusable modular bottle platform shown in FIG. 1.

FIG. 8 is a rear orthogonal view of a reusable modular bottle platform shown in FIG. 1 illustrating separable top and bottom bottle portions.

FIG. 9 is an isometric view of a removable elastomeric topper of the reusable modular bottle platform shown in FIG. 1.

FIG. 10 is a cross-sectional side view of the removable elastomeric topper shown in FIG. 9.

FIG. 11 is an exploded isometric view of a reusable modular bottle platform having tactile labeling, according to another implementation.

FIG. 12 is a front orthogonal view and a rear orthogonal view of a unit-dose concentrate article, according to one implementation.

FIG. 13 is a top perspective view of the unit-dose concentrate article shown in FIG. 12 with the top of the article open.

FIG. 14 is a schematic representation of the unit-dose concentrate article shown in FIG. 12 and a top portion of the reusable bottle platform shown in FIG. 11 with corresponding tactile labeling.

### DETAILED DESCRIPTION

The present disclosure relates to a reusable modular bottle platform configured for preparing liquid solutions from concentrates. The reusable bottle platform may be used across different end uses, including household cleaning, pet cleaning, grooming, or other applications. The platform may enable consumers to prepare ready-to-use liquids from concentrates such as powders, tablets, or liquid concentrates, thereby reducing plastic waste and shipping weight associated with pre-mixed liquid products.

The reusable bottle platform may include a bottle defining an interior cavity for holding liquid. The bottle may have a neck defining a coupling interface configured to receive a dispensing head. The coupling interface may be configured to receive a plurality of interchangeable dispensing heads of different dispensing architectures. In some cases, the plurality of dispensing heads may include trigger sprayers, pump dispensers, mist sprayers, foaming pumps, pour spouts, brush-and-dispense heads, squeeze valves, or combinations thereof.

The reusable bottle platform may include a fill indicator integrated as a structural feature of an outer surface of the bottle. The fill indicator may define a single predetermined fill volume for the bottle. The fill indicator may provide a fixed and invariant fill instruction for the bottle regardless of which dispensing head of the plurality of dispensing heads is installed on the coupling interface. In some cases, the fill indicator may comprise a molded paw icon formed in an exterior wall of the bottle. The fill indicator may be disposed on an upper sidewall region of the bottle.

The reusable bottle platform may include at least one aperture defined by and extending through a wall portion of the bottle that defines the interior cavity. The at least one aperture may be positioned at or above a fill elevation corresponding to the fill indicator. The at least one aperture may be configured to communicate the interior cavity with an exterior of the bottle such that liquid introduced into the interior cavity above the fill elevation corresponding to the fill indicator is able to flow through the at least one aperture. In this manner, the fill indicator and the at least one aperture may cooperate to define a mechanically enforced fill condition in which the single predetermined fill volume is self-limiting.

The reusable bottle platform may include a removable elastomeric topper configured to seat on an exterior surface of the bottle. The topper may interface with the at least one aperture to provide venting functionality for gas-generating mixtures while limiting leakage during upright storage and ordinary handling.

The bottle may comprise a top bottle portion and a bottom bottle portion that are separably couplable to each other. The separable configuration may permit user disassembly for cleaning and direct access to interior surfaces of both portions. In some cases, different bottom bottle portions may be interchanged with a common top bottle portion to define different total capacities while maintaining the same fill indicator position on the top bottle portion.

Various implementations include a reusable bottle platform. The reusable bottle platform includes a bottle defining an interior cavity and having a neck defining a coupling interface configured to receive a dispensing head. The neck defines a channel in fluid communication with the interior cavity. The reusable bottle platform includes a fill indicator integrated as a structural feature of an outer surface of the bottle. The fill indicator defines a single predetermined fill volume. The reusable bottle platform includes at least one aperture defined by and extending through a wall portion of the bottle that defines the interior cavity. The at least one aperture is positioned at or above a fill elevation corresponding to the fill indicator. The at least one aperture is configured to communicate the interior cavity with an exterior of the bottle such that liquid introduced into the interior cavity above the fill elevation corresponding to the fill indicator is able to flow through the at least one aperture.

Various other implementations include a unit-dose concentrate article. The unit-dose concentrate article includes an enclosure enclosing a quantity of a material. The enclosure is defined by structural and packaging characteristics independent of chemical composition. The unit-dose concentrate article includes printed instructions provided on the enclosure. The printed instructions are configured to instruct a user to add the quantity of the concentrated material to an interior cavity defined by a bottle of a reusable bottle platform. The bottle includes a fill indicator integrated with an outer surface of the bottle. The printed instructions are configured to instruct a user to fill the interior cavity of the bottle of the reusable bottle platform with a liquid to a position corresponding to the fill indicator integrated as a molded structural feature of an outer surface of the bottle, without reference to a specific volume. The printed instructions further include a dispensing head selection mapping identifying a dispensing head type compatible with the quantity of the material when mixed to the fill indicator.

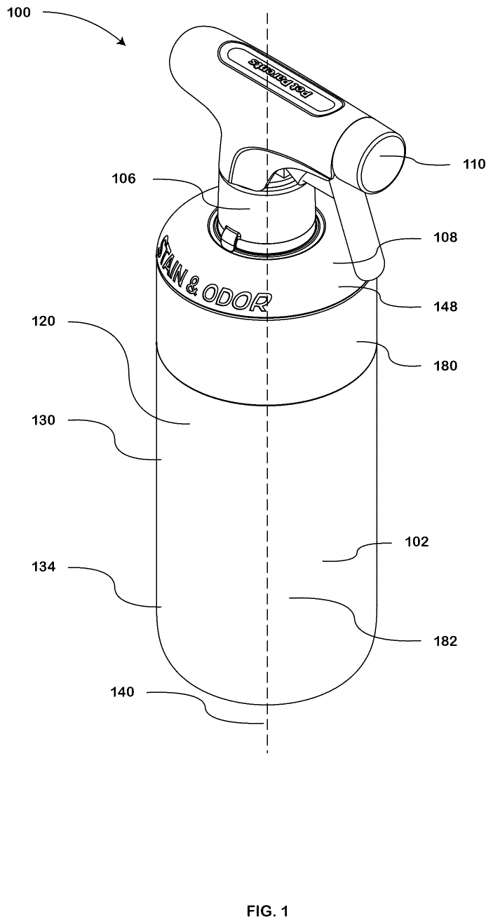

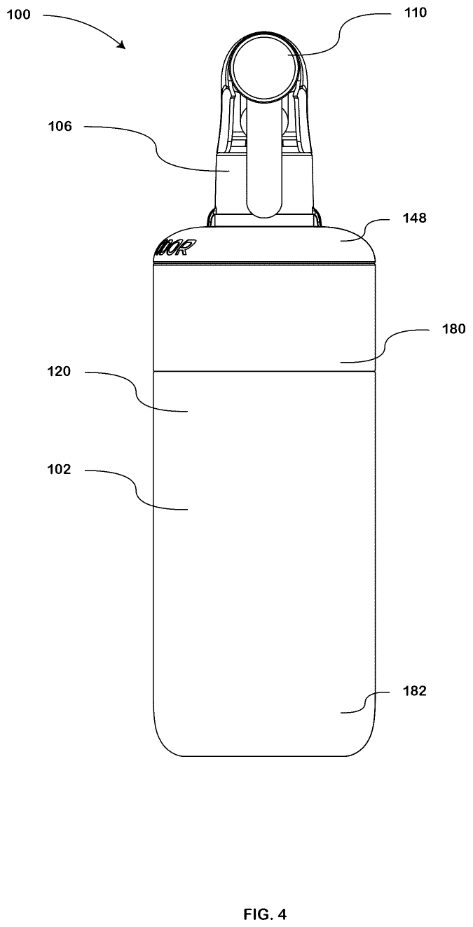

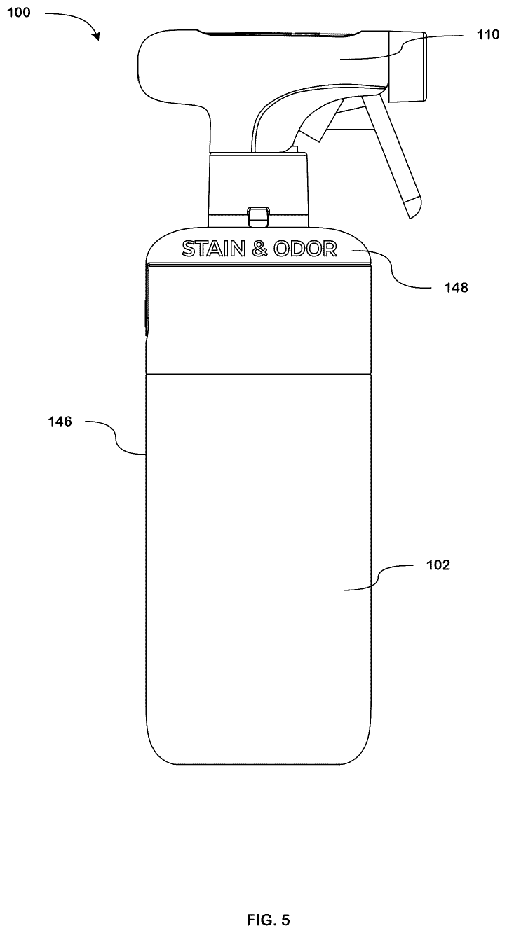

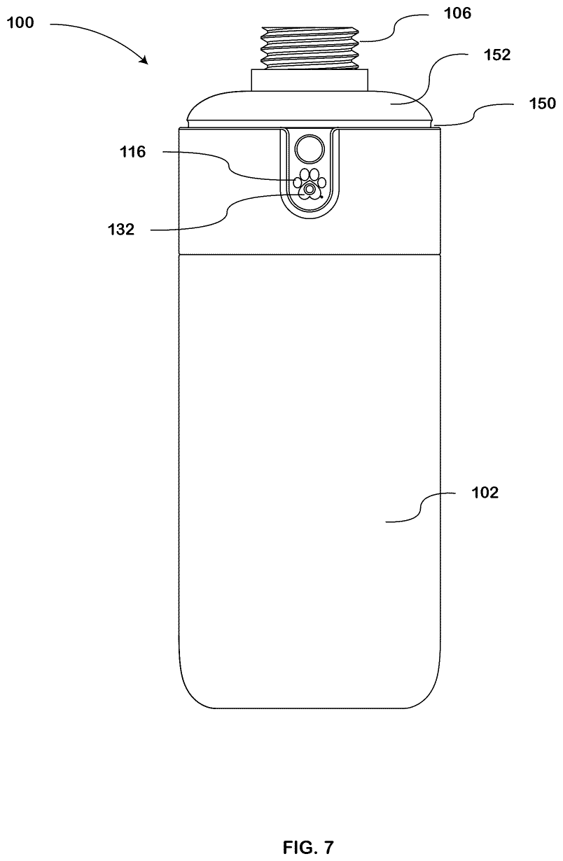

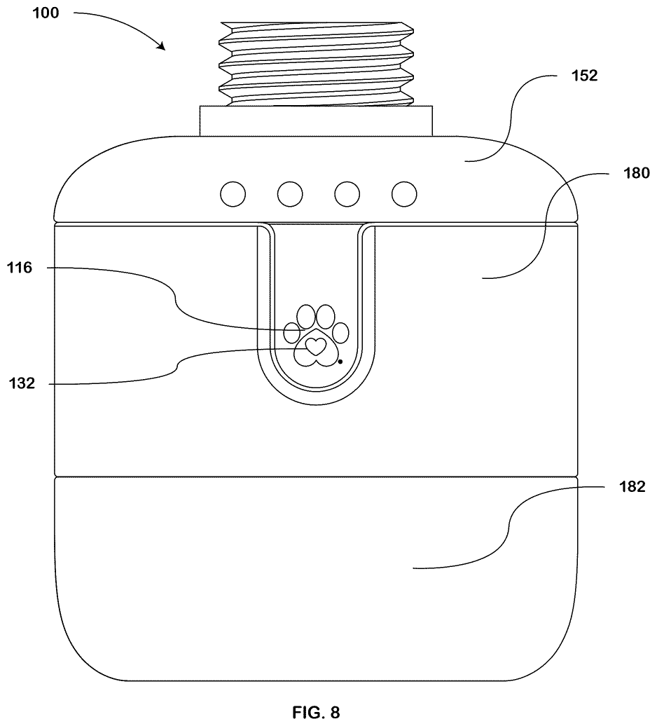

Referring to FIGS. 1-10, the reusable bottle platform 100 includes a bottle 102 defining an interior cavity 104 and having a neck 106 defining a coupling interface 108 configured to receive a dispensing head 110. The neck 106 defines a channel 112 in fluid communication with the interior cavity of the bottle 102. A trigger sprayer dispensing head 110 is coupled to the neck 106 of the bottle 102 via the coupling interface 108. The trigger sprayer includes a main body housing positioned atop the bottle neck 106, with a trigger lever extending outward from the front of the housing. The trigger lever is configured to be actuated by a user to dispense liquid from the bottle 102. A nozzle portion extends from the front of the trigger sprayer housing and is oriented to direct dispensed liquid away from the bottle 102.

The dispensing head 110 comprises an intake tube 194 extending into the interior cavity 104 of the bottle 102. The intake tube 194 extends from the trigger sprayer downward into the interior cavity of the bottle 102. The intake tube 194 is dimensioned such that when the bottle 102 is filled to a fill indicator 116 in an upright orientation, a distal end of the intake tube 194 is positioned below the liquid surface, enabling liquid to be drawn into the dispensing head 110 during actuation of the trigger lever.

A removable elastomeric topper 148 is seated on an exterior surface of the bottle 102. As shown in FIG. 1, the topper 148 is visible as a ring-shaped component positioned between the trigger sprayer and the main body of the bottle 102. The topper 148 is configured to interface with apertures 156, 158 formed in the bottle wall for venting purposes.

With continued reference to FIG. 1, a fill indicator 116 is integrated as a structural feature of an outer surface 120 of the bottle 102. The fill indicator 116 defines a single predetermined fill volume for the bottle 102. The fill indicator 116 provides a visual and tactile reference indicating the fill level to which the bottle 102 is to be filled when preparing a solution.

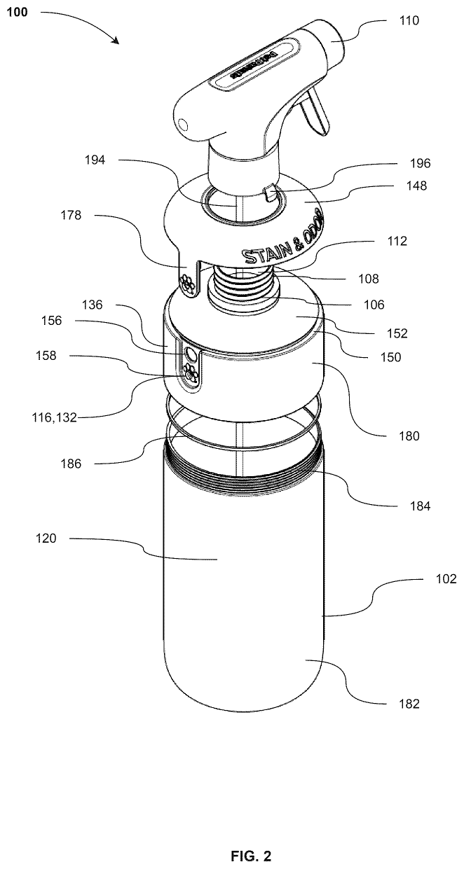

Referring to FIG. 2, an exploded isometric view shows the spatial relationship between the various separable components of the bottle system arranged along a longitudinal axis 140. The trigger sprayer dispensing head 110 is positioned at the top of the assembly and includes a handle portion with an actuating trigger mechanism and a nozzle extending from the front. The removable elastomeric topper 148 is configured as a circumferential ring component positioned below the dispensing head 110. The topper 148 includes a downwardly extending tongue portion 178 that displays product identification marking and features a molded paw icon that serves as the fill indicator 116.

In some implementations, the plurality of dispensing heads 110 comprises at least two dispensing heads selected from the group consisting of a trigger sprayer, a pump dispenser, a mist sprayer, a foaming pump, a pour spout, a brush-and-dispense head, and a squeeze valve. In some implementations, when a solution is prepared by filling the bottle 102 to the fill indicator 116, a first dispensing head may produce a spray output or mist output, while a second dispensing head may produce a foam output or pour output, while the bottle 102 remains filled to the same fill indicator 116 corresponding to the single predetermined fill volume.

In some implementations, different dispensing heads 110 with the same single predetermined fill volume are configured to produce different numbers of discrete dispensing actions from a same volume of the liquid. A filled bottle 102 may deliver on the order of tens to hundreds of dispensing actions per fill, with bottle configurations having smaller total liquid volumes delivering fewer dispensing actions and bottle configurations having larger total liquid volumes delivering more dispensing actions.

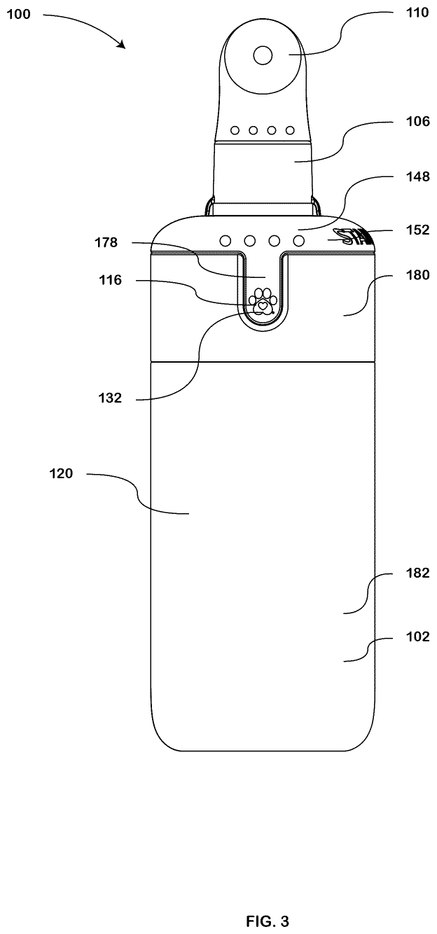

Referring to FIG. 3, the bottle 102 comprises a main body portion having a generally rectangular profile with rounded corners at the bottom. The bottle 102 includes an exterior sidewall extending upward from the bottom portion to a shoulder region 152 that transitions to a neck portion 106. The neck portion 106 extends upward and terminates in a coupling interface 108 configured to receive a dispensing head 110. The bottle 102 includes a longitudinal axis 140 extending through the center of the bottle 102 from the bottom portion to the neck portion 106. When the bottle 102 is in an upright orientation defined by a gravitational axis, a surface of liquid within the bottle 102 is perpendicular to the longitudinal axis 140.

The fill indicator 116 is integrated as a structural feature of an outer surface 120 of the bottle 102. As shown in FIG. 3, the fill indicator 116 comprises a molded paw icon 132 formed in an exterior wall 134 of the bottle 102. The molded paw icon 132 is disposed on a tongue portion 178 of the removable elastomeric topper 148 that extends downwardly along the rear face of the bottle 102. The fill indicator 116 is disposed on an upper sidewall region 136 of the bottle 102 relative to the gravitational axis when the bottle 102 is in the upright orientation.

With continued reference to FIG. 3, the fill indicator 116 is disposed between 0.2 cm and 12 cm below a neck datum measured along an exterior surface of the bottle 102. The neck datum is defined as a reference plane perpendicular to the longitudinal axis 140 of the bottle 102 as measured from a lower boundary of the coupling interface 108. The positioning of the fill indicator 116 within this measurement band provides a consistent visual and tactile reference for filling the bottle 102 to the single predetermined fill volume.

The bottle body below the shoulder region 152 and the fill indicator 116 defines the interior cavity 104 for holding liquid mixtures. The fill indicator 116 formed as the molded paw icon 132 serves as a visual reference indicating the fill level to which the bottle 102 is to be filled when preparing a solution. The fill indicator 116 remains fixed and visible from the exterior 130 of the bottle 102 regardless of which dispensing head 110 is installed on the coupling interface 108.

In some implementations, the fill indicator 116 may comprise alternative molded structural features other than a paw icon, such as a line, a geometric shape, or other visual marking formed in the exterior wall 134 of the bottle 102. In some implementations, the fill indicator 116 may be positioned at different locations within the measurement band between 0.2 cm and 12 cm below the neck datum depending on the desired single predetermined fill volume for a particular bottle configuration.

Referring to FIGS. 2, 6, and 7, the bottle 102 includes at least one aperture 156 defined by and extending through a wall portion of the bottle 102 that defines the interior cavity 104. The at least one aperture 156 is positioned at or above a fill elevation corresponding to the fill indicator 116. The at least one aperture 156 is configured to communicate the interior cavity 104 with an exterior 130 of the bottle 102 such that liquid introduced into the interior cavity 104 above the fill elevation corresponding to the fill indicator 116 is able to flow through the at least one aperture 156.

The at least one aperture 156 is defined by a sidewall region of the wall portion of the bottle 102. The aperture extends through the exterior sidewall in an upper region of the bottle 102 below the neck 106 and above the primary body region. The positioning of the aperture at or above the fill elevation corresponding to the fill indicator 116 provides a mechanically enforced fill condition. When liquid is introduced into the interior cavity 104 and rises above the fill elevation, the liquid reaches the aperture and is able to flow through the aperture to the exterior 130 of the bottle 102. This configuration prevents stable retention of liquid above the fill elevation, thereby making the single predetermined fill volume self-limiting and independent of user intent or instruction.

The fill indicator 116 on the tongue portion 178 of the topper 148 is positioned below the aperture location on the sidewall. The topper 148 shown in the figures displays text reading “STAIN & ODOR” and marks the fill level for the bottle 102, but in some implementations, the topper can include any text or images instead of or in addition to “STAIN & ODOR”. The aperture and the fill indicator 116 cooperate such that overfilling beyond the fill indicator 116 is physically inhibited by discharge of excess liquid through the aperture.

In some implementations, the at least one aperture 156 is defined by a shoulder region 152 of the wall portion of the bottle 102. The shoulder region 152 is located at the transition between the neck 106 and the primary body region of the bottle 102. An aperture formed through the shoulder region 152 communicates the interior cavity 104 with the exterior 130 of the bottle 102 at a location above the fill elevation corresponding to the fill indicator 116.

In some implementations, the at least one aperture 156 is defined by a top wall region of the wall portion of the bottle 102. The top wall region is located adjacent to the neck 106 and above the shoulder region 152. An aperture formed through the top wall region communicates the interior cavity 104 with the exterior 130 of the bottle 102 at a location above the fill elevation corresponding to the fill indicator 116.

In some implementations, the at least one aperture 156 is positioned above the fill elevation corresponding to the fill indicator 116, such as when the aperture is formed through a top wall region of the bottle 102. In such configurations, liquid filled above the fill indicator 116 may not immediately escape through the aperture. Instead, the liquid volume above the fill indicator 116 reduces the available headspace within the interior cavity 104. The reduced headspace limits the volume available for gas accumulation from gas-generating formulations mixed within the bottle 102. As gas is generated by the formulation during storage, the reduced headspace may cause increased internal pressure within the bottle 102. The increased internal pressure may destabilize the seal between the topper 148 and the bottle 102, or may destabilize the seal at the topper 148 or between the top bottle portion 180 and the bottom bottle portion 182 at the gasket 186. In some cases, the increased internal pressure resulting from overfilling may compromise sealing integrity during storage, potentially leading to leakage or seal failure. This configuration provides an indirect overfill deterrent in which overfilling beyond the fill indicator 116 increases the risk of seal destabilization rather than causing immediate liquid discharge through the aperture.

In some implementations, the at least one aperture 156 is formed through a transition region between the sidewall and the neck 106. The transition region provides an alternative location for the aperture while maintaining the aperture at or above the fill elevation corresponding to the fill indicator 116. Regardless of the specific location of the aperture within the sidewall region, shoulder region 152, top wall region, or transition region, the aperture is configured to communicate the interior cavity 104 with the exterior 130 of the bottle 102 such that liquid introduced above the fill elevation flows through the aperture to prevent overfilling.

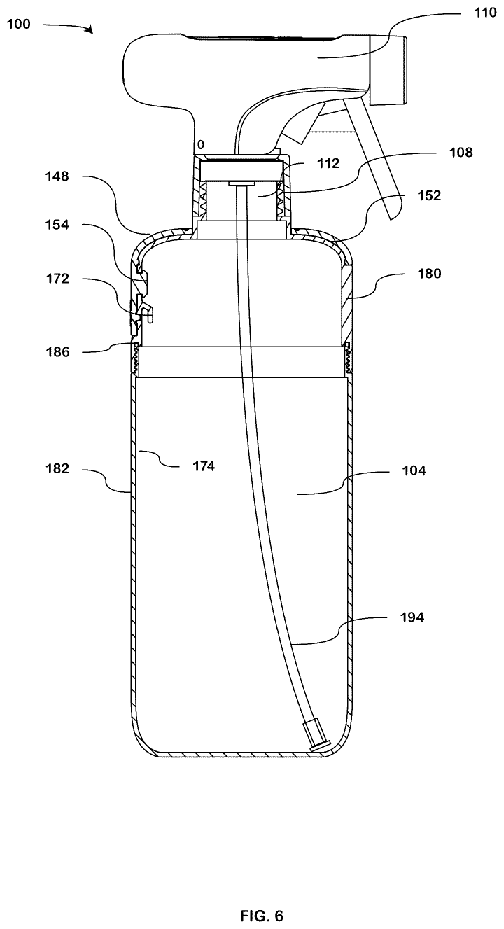

The bottle 102 comprises a top bottle portion 180, a bottom bottle portion 182, and a coupling 184. The top bottle portion 180 is separably couplable to the bottom bottle portion 182 by the coupling 184. The top bottle portion 180 and the bottom bottle portion 182 together define the interior cavity 104 when assembled. The cross-sectional view of FIG. 6 reveals the internal structure and components of the assembled bottle system, showing the top bottle portion 180 and the bottom bottle portion 182 joined together by a user-separable coupling 184 located at approximately the mid-height of the container.

The coupling 184 comprises a threaded coupling. A gasket 186 is disposed at the coupling 184 between the top bottle portion 180 and the bottom bottle portion 182. The gasket 186 creates a liquid-retaining seal when the top bottle portion 180 and the bottom bottle portion 182 are assembled together. The user-separable coupling 184 permits separation of the top bottle portion 180 from the bottom bottle portion 182 to expose interior surfaces of both portions for direct access. This separable configuration enables thorough cleaning by hand or dishwasher between uses with different formulations.

In some implementations, the user-separable coupling 184 comprises alternative coupling mechanisms other than a threaded coupling. In some implementations, the user-separable coupling 184 comprises a snap-fit coupling in which one or more resilient projections on one of the top bottle portion 180 or the bottom bottle portion 182 engage corresponding recesses or undercuts on the other portion to retain the portions in an assembled condition. In some implementations, the user-separable coupling 184 comprises a friction-fit coupling in which interference between mating surfaces of the top bottle portion 180 and the bottom bottle portion 182 retains the portions in an assembled condition. In some implementations, the user-separable coupling 184 comprises a magnetic coupling in which magnetic elements disposed on the top bottle portion 180 and the bottom bottle portion 182 attract each other to retain the portions in an assembled condition. In some implementations, the user-separable coupling 184 comprises a latch coupling in which one or more pivoting or sliding latch elements engage corresponding features to secure the top bottle portion 180 to the bottom bottle portion 182. In some implementations, the user-separable coupling 184 comprises a twist-lock coupling in which rotational movement of one portion relative to the other engages interlocking features to retain the portions in an assembled condition. In each of these implementations, the gasket 186 can be disposed at the coupling 184 between the top bottle portion 180 and the bottom bottle portion 182 to create a liquid-retaining seal when the portions are assembled together.

The top bottle portion 180 includes the neck region 106 with the coupling interface 108 configured to receive the dispensing head 110. The top bottle portion 180 includes the shoulder region 152 where the removable elastomeric topper 148 is seated. The top bottle portion 180 transitions to a threaded coupling region at a lower extent of the top bottle portion 180. The bottom bottle portion 182 provides the primary liquid storage volume and features rounded corners at the base. The bottom bottle portion 182 includes external threading at an upper region of the bottom bottle portion 182 configured to engage with corresponding internal threading on the top bottle portion 180.

The threaded coupling and the gasket 186 are cooperatively configured such that sealing engagement between the top bottle portion 180 and the bottom bottle portion 182 occurs when the bottom bottle portion 182 has a mating thread profile and gasket-engagement geometry corresponding to the top bottle portion 180. A non-matching bottom bottle portion is unable to compress the gasket 186 to a sealing condition due to axial misalignment, insufficient axial travel, or interference between thread profiles, such that leakage or failure to retain liquid occurs if assembly is attempted. This selective compatibility permits user-separable disassembly for cleaning while inhibiting unintended substitution of non-compatible bottom bottle portions.

The fill indicator 116 is disposed on the top bottle portion 180 such that the fill indicator 116 remains fixed and visible from the exterior 130 of the bottle 102 regardless of which bottom bottle portion 182 is attached. The fill indicator 116 formed as the molded paw icon 132 is positioned on the tongue portion 178 of the topper 148, which extends downwardly from the shoulder region 152 of the top bottle portion 180. A user-separable coupling 184 joins the top bottle portion 180 to the bottom bottle portion 182. The user-separable coupling 184 is disposed below a thread region of the coupling interface 108 at the neck 106.

The gasket 186 is seated in a circumferential groove positioned relative to a termination of the thread profile. The circumferential groove positions the gasket 186 to engage with a corresponding surface of the bottom bottle portion 182 when the threaded coupling is tightened. The gasket 186 is positioned and dimensioned relative to the threaded coupling such that a liquid-retaining seal is achieved when the bottom bottle portion 182 has the mating thread profile and the corresponding gasket-engagement geometry configured for the top bottle portion 180.

In some implementations, the threaded coupling has a diameter between 15 mm and 150 mm and a thread height between 2 mm and 30 mm. In some implementations, the threaded coupling diameter and thread height are selected based on the overall size of the bottle 102 and the desired sealing force at the gasket 186 interface. In some implementations, the thread profile comprises a single-start thread, a multi-start thread, or a buttress thread profile configured to provide axial compression of the gasket 186 when the top bottle portion 180 and the bottom bottle portion 182 are assembled.

In some implementations, different bottom bottle portions 182 define different total interior cavities 104 below the fill indicator 116 while preserving the single predetermined fill volume defined by the fill indicator 116 on the top bottle portion 180. In some implementations, a common top bottle portion 180 is configured to receive a plurality of different bottom bottle portions 182, each bottom bottle portion 182 having the mating thread profile and gasket-engagement geometry corresponding to the top bottle portion 180. In some implementations, the separable configuration of the top bottle portion 180 and the bottom bottle portion 182 permits interchange of bottom bottle portions 182 of different capacities while maintaining consistent fill behavior, sealing integrity, and compatibility with the dispensing head 110 and intake tube 194 configuration of the reusable bottle platform 100.

Referring to FIG. 2, the bottle 102 includes a continuous circumferential shoulder groove 150 formed around the exterior of the bottle 102 at a shoulder region 152 located below the neck 106. The removable elastomeric topper 148 is configured to seat within the continuous circumferential shoulder groove 150. The topper 148 is configured to be retained on the bottle 102 by elastic interference between the topper 148 and the shoulder groove 150. The elastic interference provides a secure fit that maintains the topper 148 in position on the bottle 102 during handling and use.

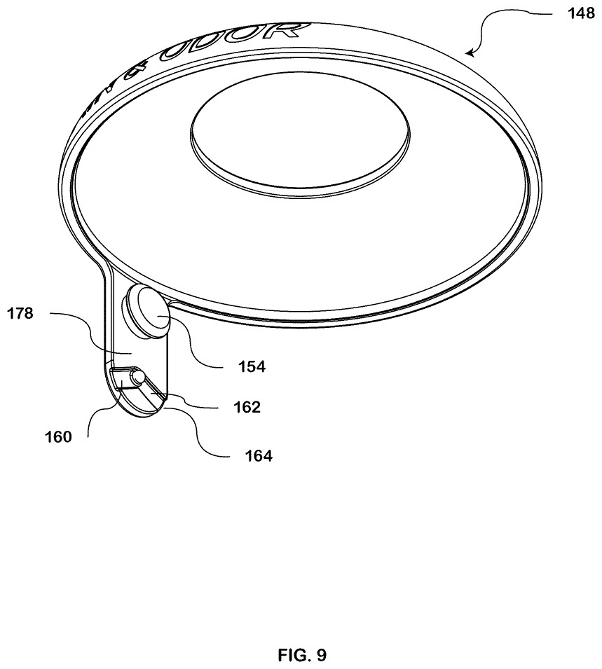

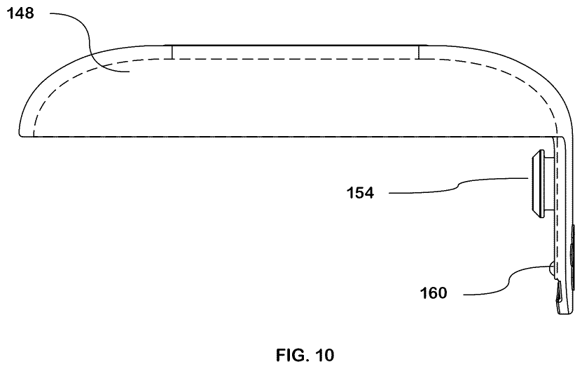

As shown in FIGS. 9 and 10, the topper 148 includes a tongue portion 178 extending axially from the topper 148. The tongue portion 178 extends downwardly along the upper sidewall of the bottle 102 when the topper 148 is seated in the shoulder groove 150. The tongue portion 178 comprises the fill indicator 116. The fill indicator 116 is formed as a molded paw-shaped icon 132 on the tongue portion 178. Above the paw icon 132 on the tongue portion 178, a circular aperture is visible, corresponding to a plug aperture configured to be sealed by a plug portion 154 of the topper 148.

With continued reference to FIGS. 6, 9, and 10, the topper 148 comprises a plug portion 154 configured to seal the at least one aperture 156. The plug portion 154 projects inward from the topper 148 and engages the plug aperture to create a seal that prevents liquid from escaping through the plug aperture during storage and handling. The plug portion 154 and the tongue portion 178 are integrated components of the topper 148 that provide both sealing functionality and visual fill indication.

Referring to FIGS. 9 and 10, the topper 148 is formed as a circumferential ring component having a generally disc-shaped body with a central opening. The upper surface of the topper 148 includes text or branding extending around the perimeter of the ring. The topper body includes a raised central region surrounding the central opening, which corresponds to a shoulder-seating configuration for engagement with the bottle shoulder groove 150. The tongue portion 178 extends downwardly from one side of the topper body and projects below the main ring plane.

As further shown in FIGS. 6, 9, and 10, the tongue portion 178 includes the plug portion 154 configured to engage and seal the plug aperture on the bottle 102. The tongue portion 178 also includes a formed vent channel 160 that routes gas from a vent aperture to an outlet region 164 open to atmosphere at the end of the tongue. The tongue portion 178 incorporates the fill indicator 116 formed as the molded paw icon 132 to visually and tactilely indicate a fill level when the topper 148 is installed on the bottle 102.

The tongue portion 178 aligns with the vent aperture and defines both an inlet region 162 of the vent channel 160 and the fill indicator 116. The vent aperture and the fill indicator 116 are integrated and disposed at the same vertical height on the bottle 102, such that gas exiting the vent aperture is routed outward at the fill indicator 116 location. This co-location of the vent aperture and the fill indicator 116 on the tongue portion 178 provides a compact arrangement that combines venting functionality with fill level indication.

The vent aperture is located within a vertical band measured along the exterior sidewall of the bottle 102 between 0.2 cm and 12 cm below a neck datum. The neck datum is defined as a reference plane perpendicular to the longitudinal axis 140 of the bottle 102 at a lower boundary of the coupling interface 108. The positioning of the vent aperture within this vertical band places the vent aperture in the upper region of the bottle 102 where gas accumulation occurs during storage of gas-generating mixtures.

In some implementations, the tongue portion 178 extends a different axial distance from the topper body depending on the vertical position of the vent aperture and fill indicator 116 on a particular bottle configuration. In some implementations, the fill indicator 116 on the tongue portion 178 comprises alternative molded structural features other than a paw icon, such as a line, a geometric shape, or other visual marking. In some implementations, the vent aperture is positioned at different locations within the vertical band between 0.2 cm and 12 cm below the neck datum depending on the desired fill elevation for a particular bottle configuration. In some implementations, the plug portion 154 and the tongue portion 178 are formed as separate projections from the topper body rather than being integrated into a single tongue structure.

Referring to FIGS. 1-10, the at least one aperture can comprise a first aperture 156 and a second aperture 158. The first aperture 156 and the second aperture 158 are formed through a wall portion of the bottle 102 that defines the interior cavity 104. The first aperture 156 and the second aperture 158 are disposed in an upper region of the bottle 102 relative to a gravitational axis when the bottle 102 is in an upright orientation. The first aperture 156 is configured as a plug aperture and the second aperture 158 is configured as a vent aperture.

The first aperture 156 has a first cross-sectional dimension and the second aperture 158 has a second cross-sectional dimension. The first cross-sectional dimension is larger than the second cross-sectional dimension. The difference in cross-sectional dimensions between the first aperture 156 and the second aperture 158 distinguishes the plug aperture from the vent aperture and provides different functional characteristics for each aperture.

The topper 148 comprises a plug portion 154 configured to seal the first aperture 156. The plug portion 154 projects inward from the topper 148 and engages the first aperture 156 to create a seal that prevents liquid and gas from escaping through the first aperture 156. The topper 148 further comprises a vent channel 160 extending from an inlet region 162 aligned with the second aperture 158 to an outlet region 164 open to the exterior 130 of the bottle 102. The vent channel 160 is a molded recessed groove formed in the topper 148. The vent channel 160 is a formed structural recess defined in the topper body and is not an incidental clearance formed by assembly tolerances.

When the topper 148 is installed on the bottle 102, the plug portion 154 seals the first aperture 156, and the vent channel 160 aligns with the second aperture 158 to provide a defined gas flow path from the interior cavity 104 of the bottle 102 to atmosphere. The venting system is configured such that internal gas generated within the bottle 102 is released through the second aperture 158 and the vent channel 160 while liquid escape through the second aperture 158 is inhibited during upright storage and during tilting associated with ordinary handling.

The topper 148 is configurable between a first configuration in which the first aperture 156 is sealed while the vent channel 160 communicates the second aperture 158 with the exterior 130 of the bottle 102, and a second configuration in which the topper 148 seals both the first aperture 156 and the second aperture 158. In the first configuration, gas generated within the interior cavity 104 exits the bottle 102 through the second aperture 158 and the vent channel 160. In the second configuration, gas generated within the interior cavity 104 remains within the bottle 102. The dual configuration of the topper 148 permits selection of a venting mode corresponding to the gas-generation characteristics of a particular formulation mixed within the bottle 102.

The venting system provides tilt-resistant venting during ordinary handling of the bottle 102. Liquid is inhibited from flowing through the second aperture 158 when the bottle 102 is tilted during normal use, such as when the bottle 102 is picked up, carried, or positioned for dispensing. Liquid exits the second aperture 158 when the bottle 102 is inverted beyond normal handling orientations. This configuration permits controlled release of gas while preventing liquid leakage during typical storage and handling conditions.

In some implementations, the topper 148 includes multiple plug configurations. A first plug configuration comprises a single plug portion 154 that seals the first aperture 156 while permitting venting through the second aperture 158 via the vent channel 160. A second plug configuration comprises two plug portions that seal both the first aperture 156 and the second aperture 158 to disable venting for formulations that do not generate gas. In some implementations, separate toppers are provided for vent-enabled and sealed operation rather than a single topper 148 configurable between the two configurations. In some implementations, the vent channel 160 extends along a curved path from the inlet region 162 to the outlet region 164 to increase the flow path length and reduce the likelihood of liquid reaching the outlet region 164 during tilting. In some implementations, the outlet region 164 of the vent channel 160 is positioned at an exterior edge of the topper 148 such that gas exits the topper 148 at a location spaced from the second aperture 158.

As shown in FIG. 6, the reusable bottle platform 100 includes an internal shield rib 172 disposed on an interior surface 174 of the bottle 102 adjacent the second aperture 158. The internal shield rib 172 is formed on the interior surface 174 of the bottle wall and is positioned adjacent to the second aperture 158 configured as the vent aperture. The internal shield rib 172 projects inward from the wall portion and downward relative to a gravitational axis when the bottle 102 is in the upright orientation. The downward projection of the internal shield rib 172 relative to the second aperture 158 blocks direct liquid impingement on the vent aperture when the bottle 102 is tilted during handling.

The internal shield rib 172 extends across 7 percent to 95 percent of a horizontal span of the second aperture 158. The horizontal span of the second aperture 158 is measured in a direction perpendicular to the longitudinal axis 140 of the bottle 102. The coverage of the internal shield rib 172 across the horizontal span of the second aperture 158 provides partial shielding of the vent aperture from liquid contact while permitting gas to flow around the internal shield rib 172 and through the second aperture 158 to the vent channel 160.

The internal shield rib 172 is spaced from the second aperture 158 by a distance between 0.2 mm and 20 mm. The spacing between the internal shield rib 172 and the second aperture 158 provides a gap through which gas flows from the interior cavity 104 to the second aperture 158 while the internal shield rib 172 deflects liquid away from the second aperture 158 during tilting. The combination of the inward and downward projection of the internal shield rib 172, the coverage across the horizontal span of the second aperture 158, and the spacing from the second aperture 158 cooperate to reduce liquid impingement on the vent aperture when the bottle 102 is tilted during ordinary handling while permitting controlled release of gas generated within the interior cavity 104.

In some implementations, the internal shield rib 172 extends across a smaller percentage of the horizontal span of the second aperture 158, such as between 7 percent and 50 percent, to provide reduced shielding while maintaining gas flow capacity through the second aperture 158. In some implementations, the internal shield rib 172 extends across a larger percentage of the horizontal span of the second aperture 158, such as between 50 percent and 95 percent, to provide increased shielding for formulations that generate foam or have lower surface tension. In some implementations, the spacing between the internal shield rib 172 and the second aperture 158 is selected based on the viscosity of solutions prepared within the bottle 102, with smaller spacing providing increased resistance to liquid flow toward the second aperture 158 and larger spacing providing reduced resistance to gas flow through the second aperture 158. In some implementations, the internal shield rib 172 comprises a curved profile that deflects liquid downward and away from the second aperture 158 when the bottle 102 is tilted. In some implementations, the internal shield rib 172 comprises a plurality of rib segments spaced apart along the horizontal span of the second aperture 158 rather than a single continuous rib structure.

Referring to FIGS. 1-10, the dispensing head 110 is removably couplable to the coupling interface 108 of the bottle 102. The dispensing head 110 includes a keyed engagement feature 196 configured to correspond to a specific feature of the removable elastomeric topper 148 such that the dispensing head 110 is installable on the coupling interface 108 when the removable elastomeric topper 148 having the corresponding specific feature is seated on the bottle 102. The keyed engagement feature 196 is configured to align the vent channel 160 of the removable elastomeric topper 148 with the second aperture 158 when the dispensing head 110 is assembled on the coupling interface 108.

The dispensing head 110 compresses the topper 148 against an annular seating surface of the bottle 102. When the dispensing head 110 is coupled to the coupling interface 108, the dispensing head 110 applies axial force to the topper 148, compressing the topper 148 between the dispensing head 110 and the annular seating surface on the bottle 102. This compression prevents axial displacement of the topper 148 during use and maintains the topper 148 in a seated position within the continuous circumferential shoulder groove 150.

The dispensing head 110 includes at least one keyed engagement feature 196 configured to mechanically engage a corresponding keyed feature of the topper 148 to define a predetermined seating orientation between the dispensing head 110 and the topper 148. The predetermined seating orientation positions the dispensing head 110 relative to the topper 148 such that the vent channel 160 of the topper 148 aligns with the second aperture 158 formed in the bottle wall. The keyed engagement feature 196 maintains alignment of the vent channel 160 with the second aperture 158 during installation and use, ensuring that gas generated within the interior cavity 104 flows through the second aperture 158 and the vent channel 160 to atmosphere.

The keyed engagement feature 196 of the dispensing head 110 differs in at least one of geometry, number, spacing, orientation, or profile between dispensing head configurations. Different dispensing heads 110 include keyed engagement features 196 having different structural characteristics that correspond to different topper configurations. The topper 148 includes a corresponding keyed feature configured to receive a dispensing head 110 having a matching keyed engagement geometry. A dispensing head 110 having a non-matching keyed engagement geometry is prevented from fully seating or sealing the topper 148 when coupled to the bottle 102.

The dispensing head 110 includes a lower sealing surface configured to seat within a recess formed in the topper 148 when the keyed engagement geometry matches, thereby forming an additional sealing interface between the dispensing head 110 and the topper 148. When the keyed engagement geometry of the dispensing head 110 matches the corresponding keyed feature of the topper 148, the lower sealing surface engages the recess in the topper 148 to compress the topper 148 and create a sealing interface in addition to sealing at the shoulder groove 150 and at the plug portion 154 sealing the first aperture 156.

The keyed engagement geometry of the dispensing head 110 corresponds to a topper 148 having a venting configuration corresponding to a formulation class. Dispensing heads 110 having differing flow characteristics are mechanically constrained to engage toppers 148 having corresponding venting configurations. This correspondence between dispensing head keyed engagement geometry and topper venting configuration provides mechanical coordination between the dispensing head type and the venting mode of the topper 148.

The keyed engagement features 196 comprise prongs, projections, recesses, tabs, slots, ribs, or combinations thereof. The geometry, number, spacing, orientation, or profile of the keyed engagement features 196 differs between dispensing head configurations. The keyed engagement features 196 are structural and mechanical in nature and do not rely on electronic identification, sensors, or chemical interactions.

In some implementations, the keyed engagement feature 196 comprises a plurality of prongs extending from the dispensing head 110 that engage corresponding slots formed in the topper 148. In some implementations, the keyed engagement feature 196 comprises projections extending from the dispensing head 110 that engage corresponding recesses formed in the topper 148. In some implementations, the keyed engagement feature 196 comprises ribs formed on the dispensing head 110 that engage corresponding grooves formed in the topper 148. In some implementations, the keyed engagement feature 196 comprises tabs extending from the dispensing head 110 that engage corresponding apertures formed in the topper 148. In some implementations, the keyed engagement features 196 are formed integrally with the dispensing head body. In some implementations, the keyed engagement features 196 are formed as separate components attached to the dispensing head 110. In some implementations, the corresponding keyed features of the topper 148 are formed integrally with the topper body. In some implementations, the number of keyed engagement features 196 on the dispensing head 110 corresponds to the number of corresponding keyed features on the topper 148 to define a single predetermined seating orientation. In some implementations, the spacing of the keyed engagement features 196 around the dispensing head 110 is nonuniform to define a single angular orientation at which the dispensing head 110 seats on the topper 148.

The reusable bottle platform 100 includes a plurality of dispensing heads 110, and each dispensing head 110 of the plurality of dispensing heads includes an intake tube 194 extending into the interior cavity 104 of the bottle 102. Each of the plurality of dispensing heads 110 includes a same diameter intake tube 194. The uniform intake tube diameter across the plurality of dispensing heads 110 provides compatibility between different dispensing head architectures and the bottle configuration. The same diameter intake tube 194 permits interchange of dispensing heads 110 on the coupling interface 108 without requiring modification of the intake tube diameter for each dispensing head type.

A length of the intake tube 194 of each of the plurality of dispensing heads 110 is selected based on a depth of the interior cavity 104 as measured from the dispensing head 110 to a bottom portion of the interior cavity 104 opposite the dispensing head 110. The intake tube 194 length extends from a proximal end coupled to the dispensing head 110 to a distal end positioned within the interior cavity 104. The distal end of the intake tube 194 is positioned below a liquid surface corresponding to the fill indicator 116 when the bottle 102 is filled to the single predetermined fill volume in an upright orientation. The selection of intake tube 194 length based on interior cavity 104 depth ensures that the distal end of the intake tube 194 remains submerged in liquid during dispensing operations regardless of the total capacity of the bottle configuration.

Intake tubes 194 of different lengths are each configured to couple to a common intake tube interface of each dispensing head 110 of the plurality of dispensing heads. The common intake tube interface provides a standardized connection between the intake tube 194 and the dispensing head body. The common intake tube interface permits selection of an intake tube 194 length corresponding to a particular bottle configuration while maintaining compatibility with multiple dispensing head types. A first intake tube 194 having a first length couples to the common intake tube interface for use with a bottle configuration having a first interior cavity 104 depth, and a second intake tube 194 having a second length couples to the same common intake tube interface for use with a bottle configuration having a second interior cavity 104 depth different from the first interior cavity 104 depth.

In some implementations, different dispensing heads 110 of the plurality of dispensing heads include intake tubes 194 having different diameters corresponding to the respective dispensing head 110. The intake tube 194 diameter varies between dispensing head types to accommodate different flow characteristics of each dispensing head architecture. A first dispensing head 110 includes an intake tube 194 having a first diameter, and a second dispensing head 110 includes an intake tube 194 having a second diameter different from the first diameter.

In some implementations, the diameter of the intake tube 194 of each dispensing head 110 of the plurality of dispensing heads is selected based on at least one of internal flow paths, actuation mechanisms, or flow requirements of the dispensing head 110. The internal flow paths of the dispensing head 110 define passages through which liquid travels from the intake tube 194 to a dispensing outlet. The actuation mechanisms of the dispensing head 110 include trigger mechanisms, pump mechanisms, squeeze mechanisms, or other structures that generate pressure or suction to draw liquid through the intake tube 194. The flow requirements of the dispensing head 110 include volumetric flow rate, pressure drop, and velocity characteristics corresponding to the dispensing output type. The intake tube 194 diameter is selected to provide flow characteristics compatible with the internal flow paths, actuation mechanisms, and flow requirements of the respective dispensing head 110.

In some implementations, the diameter of the intake tube 194 and a length of the intake tube 194 are coordinated with both a type of the dispensing head 110 and a selected depth of the interior cavity 104 as measured from the dispensing head 110 to a bottom portion of the interior cavity 104 opposite the dispensing head 110. The coordination of intake tube 194 diameter and length with dispensing head type and interior cavity 104 depth provides a matched configuration in which the intake tube 194 delivers liquid to the dispensing head 110 at flow characteristics compatible with the dispensing head architecture while extending to a position below the liquid surface corresponding to the fill indicator 116.

In some implementations, the intake tube 194 is selected from stepped intake tubes, tapered intake tubes, rigid intake tubes, semi-rigid intake tubes, flexible intake tubes, or combinations thereof. A stepped intake tube 194 includes a first section having a first diameter and a second section having a second diameter different from the first diameter, with a transition between the first section and the second section. A tapered intake tube 194 includes a diameter that varies continuously along the length of the intake tube 194 from the proximal end to the distal end. A rigid intake tube 194 maintains a fixed shape and does not deform during handling or dispensing operations. A semi-rigid intake tube 194 maintains a general shape while permitting limited deformation during handling or dispensing operations. A flexible intake tube 194 deforms to conform to the interior cavity 104 geometry and repositions within the interior cavity 104 during handling or dispensing operations.

In some implementations, the intake tube 194 is formed integrally with the dispensing head 110. The integral intake tube 194 is molded or otherwise manufactured as a single component with the dispensing head body. The integral configuration eliminates a separate connection interface between the intake tube 194 and the dispensing head 110 and provides a fixed intake tube 194 length corresponding to the dispensing head 110.

In some implementations, the intake tube 194 is separable from the dispensing head 110. The separable intake tube 194 couples to the dispensing head 110 via a connection interface and is removable from the dispensing head 110. The separable configuration permits replacement of the intake tube 194, selection of different intake tube 194 lengths for different bottle configurations, and cleaning of the intake tube 194 separately from the dispensing head 110.

If a dispensing head 110 is installed in which the intake tube 194 does not extend below the liquid surface corresponding to the fill indicator 116 under a fill condition in which the bottle 102 is in the upright orientation and the liquid surface is coincident with the fill indicator 116, actuation of the dispensing head 110 draws air rather than liquid into the intake tube 194. The air draw failure mode occurs when the distal end of the intake tube 194 is positioned above the liquid surface, such that the intake tube inlet is exposed to air within the interior cavity 104 rather than submerged in liquid. Actuation of the dispensing head 110 generates suction at the intake tube inlet, and the suction draws air through the intake tube 194 to the dispensing head 110 rather than drawing liquid. The air draw failure mode results in failure to dispense liquid from the bottle 102 despite actuation of the dispensing head 110.

If a dispensing head 110 includes an outlet structure that becomes obstructed by a solution prepared at a dilution volume defined by the fill indicator 116, liquid flow through the outlet structure is mechanically impeded. The outlet obstruction mode occurs when the solution concentration or viscosity exceeds a flow capacity of the outlet structure. The outlet structure includes passages, orifices, nozzles, or other flow-restricting features through which liquid passes during dispensing. When the solution prepared at the dilution volume has flow characteristics that exceed the capacity of the outlet structure, liquid accumulates at the outlet structure and flow through the outlet structure is reduced or prevented. The outlet obstruction mode results in reduced dispensing output, irregular dispensing behavior, or failure to dispense liquid from the bottle 102.

The reusable bottle platform 100 can include a modular kit comprising a common top bottle portion 180 and a plurality of interchangeable bottom bottle portions 182. The common top bottle portion 180 includes the coupling interface 108 configured to receive dispensing heads 110 and the integrated fill indicator 116 defining the single predetermined fill volume. Each interchangeable bottom bottle portion 182 is configured to couple to the common top bottle portion 180 via the user-separable coupling 184 and the gasket 186. The common top bottle portion 180 coupled to a first bottom bottle portion 182 defines a first total capacity, and the common top bottle portion 180 coupled to a second bottom bottle portion 182 defines a second total capacity different from the first total capacity.

The integrated fill indicator 116 is disposed on the common top bottle portion 180 such that the integrated fill indicator 116 remains visible when either the first bottom bottle portion 182 or the second bottom bottle portion 182 is coupled. The fill indicator 116 defines a fill elevation that remains fixed and invariant on the common top bottle portion 180 regardless of which bottom bottle portion 182 is attached. Interchange of the modular bottom bottle portions 182 varies the internal liquid volume below the fixed fill elevation while the fill elevation remains invariant on the top bottle portion 180. The modular bottom bottle portions 182 are volumetrically coordinated components of the reusable bottle platform 100 governed by a single fill standard rather than arbitrary containers.

Each formula is configured for dilution using the integrated fill indicator 116 of the common top bottle portion 180 in combination with a selected bottom bottle portion 182. The dilution volume is defined by the position of the integrated fill indicator 116 and the geometry of the selected bottom bottle portion 182. Use of an incorrect bottom bottle portion 182 for a given formula produces a materially incorrect dilution. The materially incorrect dilution results from the mismatch between the formula concentration requirements and the actual liquid volume defined by the incorrect bottom bottle portion 182 in combination with the fixed fill elevation.

The plurality of dispensing heads 110 includes dispensing heads having intake tubes 194 of different lengths selected based on the bottom bottle portion 182 coupled to the common top bottle portion 180. The intake tube 194 length is selected such that the distal end of the intake tube 194 extends below the liquid surface defined by the integrated fill indicator 116 for each bottle configuration. A first bottom bottle portion 182 having a first interior cavity 104 depth is paired with an intake tube 194 having a first length, and a second bottom bottle portion 182 having a second interior cavity 104 depth different from the first interior cavity 104 depth is paired with an intake tube 194 having a second length different from the first length.

At least one dispensing head 110 is configured to receive intake tubes 194 of different lengths corresponding to different bottom bottle portions 182 while maintaining a common intake tube interface. The common intake tube interface provides a standardized connection between the intake tube 194 and the dispensing head body that accommodates intake tubes 194 of varying lengths. A single dispensing head type is usable interchangeably with multiple bottle configurations by selecting an intake tube 194 length corresponding to the selected bottom bottle portion 182 without requiring a change in dispensing head architecture.

Different dispensing heads 110 include intake tubes 194 having different intake tube architectures corresponding to the dispensing head type and the selected bottom bottle portion 182. The intake tube architecture includes structural characteristics such as diameter, wall thickness, material stiffness, and cross-sectional profile that are selected to correspond to flow requirements, internal flow paths, or actuation mechanisms of the respective dispensing head 110. Both the intake tube architecture and intake tube 194 length are coordinated with the dispensing head type and the selected bottom bottle portion 182.

The modular bottle kit further comprises at least one concentrate configured to be diluted with water filled to the integrated fill indicator 116 when the concentrate is used with one of the first bottom bottle portion 182 or the second bottom bottle portion 182. The concentrate is formulated for dilution at a dilution volume corresponding to the internal liquid volume defined by the selected bottom bottle portion 182 in combination with the fixed fill elevation on the common top bottle portion 180.

Using the concentrate with a bottom bottle portion 182 defining a different dilution volume produces a dilution outside a flow-operable range for a dispensing head 110. The flow-operable range defines a range of solution concentrations and viscosities at which liquid flows through the intake tube 194 and the dispensing outlet of the dispensing head 110 during actuation. A dilution outside the flow-operable range has a concentration or viscosity that exceeds the flow capacity of the dispensing head architecture.

Different formulations require preparation at different dilution volumes to produce solutions capable of flowing through a dispensing head 110. A formulation requires preparation at a dilution volume that yields a solution within a flow-operable range for a dispensing head 110. Use of a bottom bottle portion 182 that defines a different dilution volume produces a solution concentration that mechanically inhibits flow through the intake tube 194 or the dispensing outlet. The mechanical inhibition of flow results from the solution viscosity or concentration exceeding the capacity of the internal flow paths, orifices, or nozzles of the dispensing head 110.

In some implementations, the modular kit includes three or more interchangeable bottom bottle portions 182, each defining a different total capacity when coupled to the common top bottle portion 180. In some implementations, the interchangeable bottom bottle portions 182 include bottom bottle portions having different heights, different diameters, or different internal geometries while maintaining the mating thread profile and gasket-engagement geometry corresponding to the common top bottle portion 180. In some implementations, the concentrate is packaged with indicia identifying the bottom bottle portion 182 with which the concentrate is configured for use. In some implementations, the concentrate packaging includes visual indicators corresponding to visual indicators on the bottom bottle portion 182 to reinforce correct pairing between the concentrate and the bottom bottle portion 182. In some implementations, the flow-operable range varies between dispensing head types, such that a solution concentration within the flow-operable range for a first dispensing head type is outside the flow-operable range for a second dispensing head type. In some implementations, the concentrate is formulated to produce a solution within the flow-operable range for multiple dispensing head types when diluted to the dilution volume defined by the selected bottom bottle portion 182 and the integrated fill indicator 116.

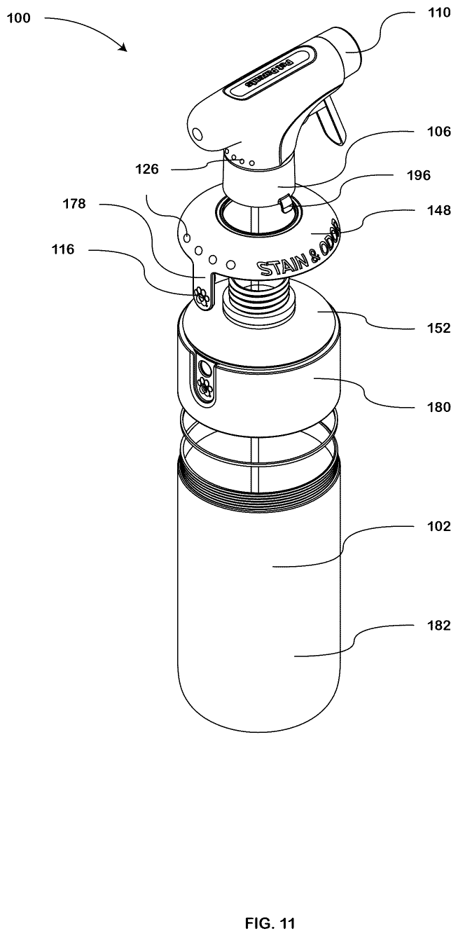

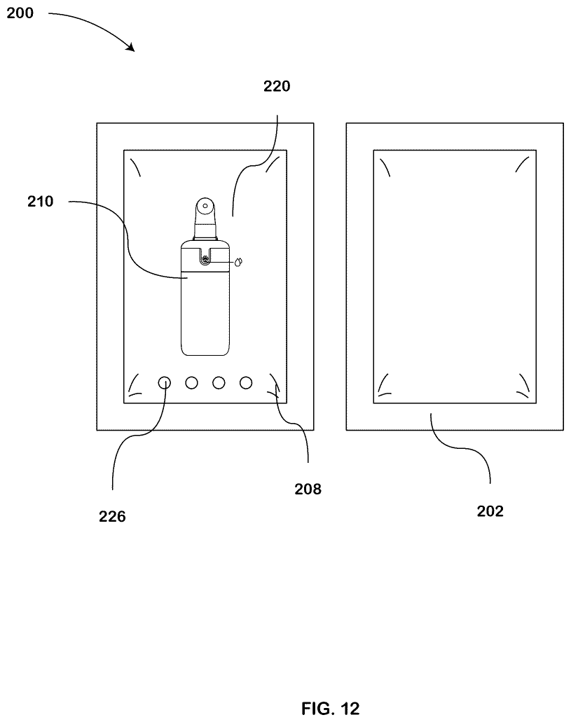

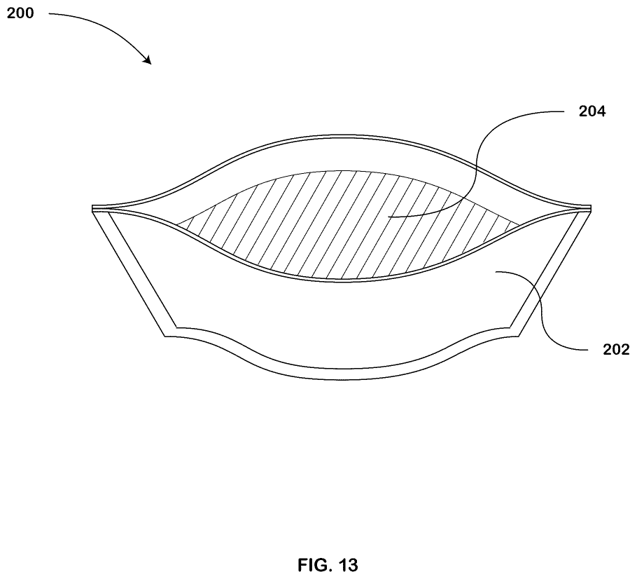

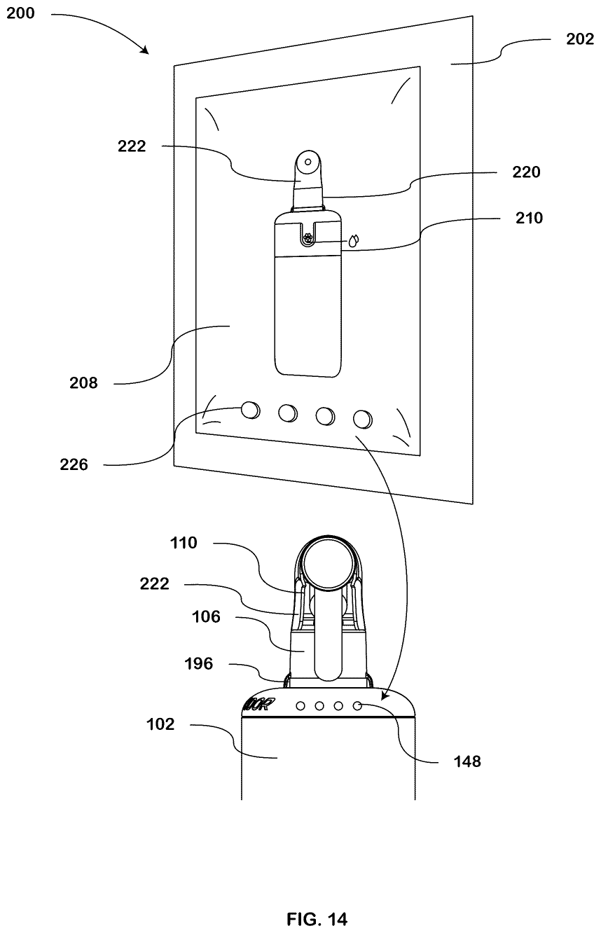

As shown in FIGS. 11-14, the reusable bottle platform 100 is configured for use with a unit-dose concentrate article 200. The unit-dose concentrate article 200 comprises an enclosure 202 enclosing a quantity of a material 204. The enclosure 202 is defined by structural and packaging characteristics independent of chemical composition. The structural and packaging characteristics include the physical form, dimensions, and construction of the enclosure 202 rather than the chemical identity or functional efficacy of the material enclosed within the enclosure 202.

The unit-dose concentrate article 200 encloses a quantity of concentrated material that, when combined with liquid filled to the integrated fill indicator 116, produces a solution having a flow behavior determined by the resulting concentration and the geometry of the dispensing head 110 installed on the bottle 102. The flow behavior of the solution includes one or more flow characteristics, such as viscosity, flow rate through a dispensing outlet, spray formation behavior, or foam formation behavior, as determined by the solution concentration and dispensing head geometry. When liquid is added to the bottle 102 to the integrated fill indicator 116, the resulting concentration of the solution defines a flow behavior that interacts with the outlet geometry and internal flow path of the dispensing head 110 during dispensing.

The unit-dose concentrate article 200 is characterized by one or more physical parameters selected from overall dimensions, mass, or dissolution time under defined conditions. The mass of the unit-dose concentrate article 200 falls within a broad range, including between approximately 0.2 grams and 453 grams, depending on the bottle configuration or dispensing head geometry.

Printed instructions 208 are provided on the enclosure 202. The printed instructions 208 are configured to instruct a user to add the quantity of the concentrated material 204 to an interior cavity 104 defined by a bottle 102 of a reusable bottle platform 100. The bottle 102 includes a fill indicator 116 integrated with an outer surface 120 of the bottle 102, as described previously. The printed instructions 208 are further configured to instruct the user to fill the interior cavity 104 of the bottle 102 of the reusable bottle platform 100 with a liquid to a position corresponding to the fill indicator 116 integrated as a molded structural feature of an outer surface 120 of the bottle 102, without reference to a specific volume. The printed instructions 208 direct filling the bottle 102 to the fill indicator 116 rather than specifying a numerical volume measurement, thereby providing a simplified and repeatable dilution instruction that corresponds to the single predetermined fill volume defined by the fill indicator 116.

The printed instructions 208 further include a dispensing head selection mapping 210 identifying a dispensing head type compatible with the quantity of the material 204 when mixed to the fill indicator 116. The dispensing head selection mapping 210 identifies at least one head type selected from a spray head, a foaming head, or a pump head. The dispensing head selection mapping 210 provides guidance to the user regarding which dispensing head architecture produces flow-operable dispensing behavior when used with the solution prepared from the unit-dose concentrate article 200 at the dilution volume defined by the fill indicator 116.

In some implementations, a first bottle configuration having a first total internal capacity and a second bottle configuration having a second total internal capacity share a common unit-dose concentrate quantity, while differing in a ratio of the unit-dose concentrate quantity to the dilution volume defined by the fill indicator 116. The ratio of the unit-dose concentrate article 200 to the dilution volume falls within a broad range, including between approximately 0.5-20% w/w, depending on the bottle configuration or dispensing head geometry.

In some implementations, the enclosure 202 comprises a sachet, a pouch, a pod, a blister, a film, a cartridge, or other single-use containment structure formed from flexible, semirigid, or rigid materials. In some implementations, the enclosure 202 comprises a water-soluble or water-dispersible material configured to dissolve or disintegrate upon contact with the liquid. The water-soluble or water-dispersible material comprises a polymer film selected to maintain structural integrity prior to use and to dissolve under defined liquid contact conditions during preparation of the solution. In some implementations, the enclosure 202 includes one or more layers selected from paper-based materials, polymer films, foil laminates, water-soluble films, or combinations thereof, and includes moisture-barrier layers or protective coatings.

In some implementations, the enclosure 202 includes a visual identifier 220 configured to correspond to a color-coded topper 222 associated with the dispensing head type identified by the dispensing head selection mapping 210. The visual identifier 220 provides a visual correspondence between the unit-dose concentrate article 200 and the topper configuration, reinforcing correct system assembly through color matching. In some implementations, the printed instructions 208 are configured to instruct use of a topper corresponding to the dispensing head type identified by the dispensing head selection mapping 210.

In some implementations, the printed instructions 208 are configured to instruct filling the interior cavity 104 of the bottle 102 of the reusable bottle platform 100 to an edge of a visual fill indicator formed on the outer surface 120 of the bottle 102 of the reusable bottle platform 100. The instruction to fill to the edge of the visual fill indicator provides a precise reference point for the user to achieve the single predetermined fill volume.

In some implementations, the enclosure 202 includes one or more tactile features 226 configured to correspond to tactile features 126 of a topper 148 or dispensing head 110 identified by the dispensing head selection mapping 210. The tactile features 226 provide physical correspondence between the unit-dose concentrate article 200 and the topper 148 or dispensing head 110, reinforcing correct system assembly through tactile matching without requiring electronic identification or chemical sensing.

In some implementations, the packaging includes visual, tactile, or dimensional features corresponding to bottle configurations or dispensing head selections. A first unit-dose concentrate is packaged in an enclosure 202 having a first longitudinal dimension corresponding to a bottle configuration having an extended bottom portion, while a second unit-dose concentrate is packaged in an enclosure 202 having a shorter longitudinal dimension corresponding to a reduced-capacity bottle configuration. The relative proportions of the packaging provide a visual correspondence to bottle configurations while preserving the same integrated fill indicator 116 and dilution volume.

In some implementations, the unit-dose concentrate article 200 includes indicia indicating a venting mode selection for the reusable bottle platform 100. A first refill type is identified for use with a vent-enabled mode, and the refill packaging includes indicia indicating that a vent-enabled topper configuration is to be used when the refill is mixed to the single predetermined fill volume. A second refill type is identified for use with a sealed mode, and the refill packaging includes indicia indicating that a sealed topper configuration is to be used when the refill is mixed to the single predetermined fill volume. The indicia include visual indicators, written instructions, tactile features 226, or combinations thereof, and correspond to vent-enabled or sealed configurations of a topper 148, or to different toppers configured for vent-enabled or sealed operation.

The enclosure 202 of the unit-dose concentrate article 200 includes a visual identifier 220 configured to correspond to a color-coded topper 222 associated with the dispensing head type identified by the dispensing head selection mapping 210. The visual identifier 220 comprises a color, pattern, or graphic element printed on or incorporated into the enclosure 202 that matches a corresponding color, pattern, or graphic element on the topper 148. The color-coded correspondence between the enclosure 202 and the topper 148 provides a visual cue to the user that reinforces correct pairing between the unit-dose concentrate article 200 and the topper configuration without requiring electronic identification or chemical sensing.

The printed instructions 208 on the enclosure 202 are configured to instruct use of a topper corresponding to the dispensing head type identified by the dispensing head selection mapping 210. The printed instructions 208 identify the topper configuration that provides venting characteristics or sealing characteristics compatible with the formulation enclosed within the unit-dose concentrate article 200 when mixed to the single predetermined fill volume. The printed instructions 208 direct the user to select and install the topper 148 having the corresponding color, tactile feature, or other identifier before preparing the solution within the bottle 102.

The printed instructions 208 are configured to instruct filling the interior cavity 104 of the bottle 102 of the reusable bottle platform 100 to an edge of a visual fill indicator formed on the outer surface 120 of the bottle 102 of the reusable bottle platform 100. The instruction to fill to the edge of the visual fill indicator provides a precise reference point that corresponds to the single predetermined fill volume defined by the fill indicator 116. The printed instructions 208 direct the user to observe the liquid level relative to the edge of the visual fill indicator rather than specifying a numerical volume measurement, thereby providing a simplified and repeatable dilution instruction.

The enclosure 202 includes one or more tactile features 226 configured to correspond to tactile features 126 of a topper 148 or dispensing head 110 identified by the dispensing head selection mapping 210. The tactile features 226 comprise raised surfaces, textured regions, embossed patterns, or shaped edges formed on the enclosure 202 that match corresponding tactile features 126 on the topper 148 or dispensing head 110. The tactile correspondence between the enclosure 202 and the topper 148 or dispensing head 110 permits identification of correct system components through touch, reinforcing correct system assembly for users who rely on tactile feedback.

The enclosure 202 comprises a water-soluble or water-dispersible material configured to dissolve or disintegrate upon contact with the liquid. The water-soluble or water-dispersible material comprises a polymer film that maintains structural integrity prior to use and dissolves under defined liquid contact conditions during preparation of the solution. The dissolution of the enclosure 202 releases the concentrated material into the liquid within the interior cavity 104 of the bottle 102, permitting mixing of the solution without requiring the user to open or tear the enclosure 202.

In some implementations, the unit-dose concentrate article 200 comprises a sachet formed from flexible materials. In some implementations, the unit-dose concentrate article 200 comprises a pouch, a pod, a blister, a film, or a cartridge. In some implementations, the enclosure 202 comprises a single-use containment structure formed from semi-rigid or rigid materials. In some implementations, the enclosure 202 includes one or more layers selected from paper-based materials, polymer films, foil laminates, water-soluble films, or combinations thereof. In some implementations, the enclosure 202 includes moisture-barrier layers or protective coatings that maintain the integrity of the concentrated material during storage prior to use.

In some implementations, the packaging includes visual, tactile, or dimensional features corresponding to bottle configurations or dispensing head selections. In some implementations, a first unit-dose concentrate is packaged in an enclosure 202 having a first longitudinal dimension corresponding to a bottle configuration having an extended bottom portion, while a second unit-dose concentrate is packaged in an enclosure 202 having a shorter longitudinal dimension corresponding to a reduced-capacity bottle configuration. The relative proportions of the packaging provide a visual correspondence to bottle configurations while preserving the same integrated fill indicator 116 and dilution volume.

In some implementations, a refill type is identified for use with a vent-enabled mode, and the refill packaging includes indicia indicating that a vent-enabled topper configuration is to be used when the refill is mixed to the single predetermined fill volume. In some implementations, a refill type is identified for use with a sealed mode, and the refill packaging includes indicia indicating that a sealed topper configuration is to be used when the refill is mixed to the single predetermined fill volume. The indicia include visual indicators, written instructions, tactile features 226, or combinations thereof, and correspond to vent-enabled or sealed configurations of a topper 148, or to different toppers configured for vent-enabled or sealed operation.

In some implementations, a single topper 148 is configurable between vent-enabled and sealed modes. In some implementations, separate toppers are provided for vent-enabled and sealed operation rather than a single topper 148 configurable between the two configurations. In some implementations, the indicia on the refill packaging identify which topper of a plurality of toppers is to be installed on the bottle 102 when the refill is mixed to the single predetermined fill volume.

In some implementations, the reusable bottle platform 100 includes a plurality of interchangeable toppers 148 configured to seat on the bottle 102, each topper having distinct visual or tactile labeling. In some implementations, different toppers 148 include different colors, text, graphics, patterns, or tactile features to distinguish between formulation types, dispensing head types, or venting configurations. In some implementations, the labeling on each topper 148 corresponds to labeling on unit-dose concentrate articles 200 to facilitate correct pairing between the topper 148 and the formulation enclosed within the unit-dose concentrate article 200. In some implementations, different toppers 148 are color-coded to correspond to different dispensing head types. For example, in some implementations, a first color corresponds to a spray head, a second color corresponds to a foaming head, and a third color corresponds to a pump head. In some implementations, different toppers 148 include different tactile features 126 to permit identification of the topper 148 by touch, enabling users to select the correct topper 148 without relying on visual identification. In some implementations, a kit includes a plurality of toppers 148 with different labeling for use with different formulations or dispensing heads, permitting a user to select a topper 148 corresponding to a particular unit-dose concentrate article 200 or dispensing head 110. In some implementations, the plurality of interchangeable toppers 148 share a common geometry for seating in the continuous circumferential shoulder groove 150 while differing in visual or tactile labeling, such that each topper 148 of the plurality of interchangeable toppers 148 is mechanically compatible with the bottle 102 regardless of the labeling configuration.

In some implementations, the reusable bottle platform 100 comprises interdependent components including the formulation, the topper 148, the dispensing head 110, the intake tube 194, and the bottom bottle portion 182. Correct matching of all components may be required for proper operation of the system. The formulation enclosed within the unit-dose concentrate article 200 may determine the required configuration of other components of the reusable bottle platform 100.

In some implementations, the formulation determines the topper configuration. Formulations that generate gas during storage or use may require a vent-enabled topper configuration in which the plug portion 154 seals the first aperture 156 while the vent channel 160 communicates the second aperture 158 with the exterior 130 of the bottle 102. Formulations that do not generate gas may be used with a sealed topper configuration in which the topper 148 seals both the first aperture 156 and the second aperture 158.

In some implementations, the formulation determines the dispensing head type. The flow characteristics of the diluted solution, including viscosity and flow rate, may correspond to a dispensing head 110 having an outlet geometry and internal flow path configured to dispense the solution. A formulation producing a solution with higher viscosity may require a dispensing head 110 having larger internal flow passages, while a formulation producing a solution with lower viscosity may be compatible with dispensing heads 110 having smaller internal flow passages or finer outlet geometries.

In some implementations, the formulation determines the bottom bottle portion 182. The formulation may be configured for dilution at a specific dilution volume defined by the combination of the fill indicator 116 on the top bottle portion 180 and the geometry of a selected bottom bottle portion 182. Different formulations may require different dilution volumes to produce solutions within a flow-operable range for a corresponding dispensing head 110.

In some implementations, the formulation determines the intake tube 194 length. The intake tube 194 length may be selected based on the bottom bottle portion 182 required for the formulation, such that the distal end of the intake tube 194 extends below the liquid surface corresponding to the fill indicator 116 when the bottle 102 is filled with the diluted solution.

In some implementations, if a gas-generating formulation is used with a sealed topper configuration having two plug portions that seal both the first aperture 156 and the second aperture 158, gas generated within the interior cavity 104 accumulates and causes pressure buildup within the bottle 102. The pressure buildup may destabilize the seal between the topper 148 and the bottle 102, may destabilize the seal between the top bottle portion 180 and the bottom bottle portion 182 at the gasket 186, may cause leakage, or may prevent proper dispensing through the dispensing head 110.

In some implementations, if a vent-enabled topper configuration is used with a formulation that does not generate gas, liquid may escape through the vent channel 160 during tilting or handling of the bottle 102. The vent channel 160 configured for gas release may permit liquid to flow from the interior cavity 104 to the exterior 130 of the bottle 102 when the bottle 102 is tilted beyond orientations associated with ordinary handling.

In some implementations, if a bottom bottle portion 182 defining an incorrect dilution volume is used with a formulation, the resulting solution may be too concentrated or too dilute. A solution that is too concentrated may have a viscosity that obstructs the dispensing head 110 outlet or the intake tube 194, mechanically inhibiting flow and preventing proper dispensing. A solution that is too dilute may affect product efficacy or may have flow characteristics outside the flow-operable range for the dispensing head 110.

In some implementations, if a dispensing head 110 incompatible with the solution viscosity or flow characteristics is installed on the bottle 102, the dispensing head 110 may become obstructed or may fail to dispense properly. The outlet geometry, internal flow paths, or actuation mechanisms of the dispensing head 110 may be incompatible with the flow characteristics of the solution, resulting in reduced dispensing output, irregular dispensing behavior, or failure to dispense.

In some implementations, if an intake tube 194 that does not extend below the liquid surface corresponding to the fill indicator 116 is installed, actuation of the dispensing head 110 draws air rather than liquid into the intake tube 194, resulting in failure to dispense liquid from the bottle 102.

In some implementations, if any one component of the reusable bottle platform 100 is incorrectly selected or mismatched with the formulation or other components, the reusable bottle platform 100 may be rendered inoperable or may fail to dispense the solution as intended. The interdependence of the formulation, the topper 148, the dispensing head 110, the intake tube 194, and the bottom bottle portion 182 may require correct matching of all components for proper operation of the reusable bottle platform 100.

A number of example implementations are provided herein. However, it is understood that various modifications can be made without departing from the spirit and scope of the disclosure herein. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. Although the terms “comprising” and “including” have been used herein to describe various implementations, the terms “consisting essentially of” and “consisting of” can be used in place of “comprising” and “including” to provide for more specific implementations and are also disclosed.

Disclosed are materials, systems, devices, methods, compositions, and components that can be used for, can be used in conjunction with, can be used in preparation for, or are products of the disclosed methods, systems, and devices. These and other components are disclosed herein, and it is understood that when combinations, subsets, interactions, groups, etc. of these components are disclosed that while specific reference of each various individual and collective combinations and permutations of these components may not be explicitly disclosed, each is specifically contemplated and described herein. For example, if a device is disclosed and discussed each and every combination and permutation of the device are disclosed herein, and the modifications that are possible are specifically contemplated unless specifically indicated to the contrary. Likewise, any subset or combination of these is also specifically contemplated and disclosed. This concept applies to all aspects of this disclosure including, but not limited to, steps in methods using the disclosed systems or devices. Thus, if there are a variety of additional steps that can be performed, it is understood that each of these additional steps can be performed with any specific method steps or combination of method steps of the disclosed methods, and that each such combination or subset of combinations is specifically contemplated and should be considered disclosed.

1. A reusable bottle platform, comprising:
a bottle defining an interior cavity and having a neck defining a coupling interface configured to receive a dispensing head, wherein the neck defines a channel in fluid communication with the interior volume;
a fill indicator integrated as a structural feature of an outer surface of the bottle, the fill indicator defining a single predetermined fill volume; and
at least one aperture defined by and extending through a wall portion of the bottle that defines the interior cavity, the at least one aperture being positioned at or above a fill elevation corresponding to the fill indicator,
wherein the at least one aperture is configured to communicate the interior cavity with an exterior of the bottle such that liquid introduced into the interior cavity above the fill elevation corresponding to the fill indicator is able to flow through the at least one aperture.

2. The reusable bottle platform of claim 1, wherein the fill indicator comprises a molded paw icon formed in an exterior wall of the bottle.

3. The reusable bottle platform of claim 1, wherein the fill indicator is disposed on an upper sidewall region of the bottle relative to the gravitational axis.

4. The reusable bottle platform of claim 1, wherein the bottle includes a longitudinal axis, and wherein the fill indicator is disposed between 0.2 cm and 12 cm below a neck datum measured along an exterior surface of the bottle, wherein the neck datum is defined as a reference plane perpendicular to the longitudinal axis of the bottle as measured from a lower boundary of the coupling interface.

5. The reusable bottle platform of claim 1, wherein the at least one aperture is defined by a sidewall region of the wall portion of the bottle.

6. The reusable bottle platform of claim 1, further comprising a removable elastomeric topper configured to seat on an exterior surface of the bottle.

7. The reusable bottle platform of claim 6, wherein the bottle includes a continuous circumferential shoulder groove formed around the exterior of the bottle at a shoulder region located below the neck, and wherein the topper is configured to seat within the continuous circumferential shoulder groove.

8. The reusable bottle platform of claim 7, wherein the topper is configured to be retained on the bottle by elastic interference between the topper and the shoulder groove.

9. The reusable bottle platform of claim 6, wherein the topper comprises a plug portion configured to seal the at least one aperture.

10. The reusable bottle platform of claim 6, wherein the at least one aperture comprises a first aperture and a second aperture, and wherein the topper comprises a plug portion configured to seal the first aperture and a vent channel extending from an inlet region aligned with the second aperture to an outlet region open to the exterior of the bottle.

11. The reusable bottle platform of claim 10, wherein the vent channel is a molded recessed groove formed in the topper.

12. The reusable bottle platform of claim 10, wherein the first aperture has a first cross-sectional dimension and the second aperture has a second cross-sectional dimension, wherein the first cross-sectional dimension is larger than the second cross-sectional dimension.

13. The reusable bottle platform of claim 10, further comprising an internal shield rib disposed on an interior surface of the bottle adjacent the second aperture.

14. The reusable bottle platform of claim 13, wherein the internal shield rib projects inward from the wall portion and upward relative to a gravitational axis.

15. The reusable bottle platform of claim 13, wherein the internal shield rib extends across 7 percent to 95 percent of a horizontal span of the second aperture.

16. The reusable bottle platform of claim 13, wherein the internal shield rib is spaced from the second aperture by a distance between 0.1 mm and 25 mm.

17. The reusable bottle platform of claim 6, wherein the topper includes a tongue portion extending axially from the topper, wherein the tongue portion comprises the fill indicator.

18. The reusable bottle platform of claim 1, wherein the bottle comprises a top bottle portion, a bottom bottle portion, and a coupling, wherein the top bottle portion is separably couplable to the bottom bottle portion by the coupling, wherein the top bottle portion and the bottom bottle portion together define the interior cavity when assembled.

19. The reusable bottle platform of claim 18, further comprising a gasket disposed at the coupling between the top bottle portion and the bottom bottle portion.

20. The reusable bottle platform of claim 18, wherein the coupling comprises a threaded coupling.

21. The reusable bottle platform of claim 19, wherein the threaded coupling and the gasket are cooperatively configured such that sealing engagement between the top bottle portion and the bottom bottle portion occurs only when the bottom bottle portion has a mating thread profile and gasket-engagement geometry corresponding to the top bottle portion.

22. The reusable bottle platform of claim 18, wherein the fill indicator is disposed on the top bottle portion such that the fill indicator remains fixed and visible from the exterior of the bottle regardless of which bottom bottle portion is attached.

23. The reusable bottle platform of claim 1, further comprising a dispensing head removably couplable to the coupling interface, the dispensing head comprising an intake tube extending into the interior cavity.

24. The reusable bottle platform of claim 23, wherein the dispensing head includes a keyed engagement feature configured to correspond to a specific feature of the removable elastomeric topper such that the dispensing head is installable on the coupling interface only when the removable elastomeric topper having the corresponding specific feature is seated on the bottle.

25. The reusable bottle platform of claim 24, wherein the keyed engagement feature is configured to align the vent channel of the removable elastomeric topper with the second aperture when the dispensing head is assembled on the coupling interface.

26. The reusable bottle platform of claim 10, wherein the topper is configurable between a first configuration in which the first aperture is sealed while the vent channel communicates the second aperture with the exterior of the bottle, and a second configuration in which the topper seals both the first aperture and the second aperture.

27.-33. (canceled)
